(19) United States
(12) Patent Application Publication
(10) Pub. No.: US 2020/0349616 A1
(43) Pub. Date: Nov. 5, 2020

(54) COMPUTER-IMPLEMENTED METHOD FOR MANAGING USER-SUBMITTED REVIEWS USING ANONYMOUS REPUTATION SYSTEM

(71) Applicant: Oxford University Innovation Limited, Oxford (GB)

(72) Inventors: Ali EL KAAFARANI, Oxford (Oxfordshire) (GB); Shuichi KATSUMATA, Kita-ku (JP)

(21) Appl. No.: 16/960,903

(22) PCT Filed: Jan. 9, 2019
(86) PCT No.: PCT/GB2019/050054

§ 371 Date: Jul. 9, 2020

(30) Foreign Application Priority Data
Jan. 11, 2018 (GB) 1800493.7

(51) Int. Cl. G06Q 30/02

(52) U.S. Cl. CPC G06Q 30/0282

(57) ABSTRACT

The disclosure relates to implementing an anonymous reputation system for managing user reviews. In one arrangement, an anonymous reputation system is constructed from a group of group signature schemes run in parallel. Each item of a plurality of items is associated uniquely with one of the group signature schemes. A user is allowed to join the group signature scheme associated with the item when information indicating that the user has performed a predetermined operation associated with the item is received. The user can submit a review of the item when the user has joined the group signature scheme associated with the item (6). The anonymous reputation system is publicly linkable and non-frameable (8a, 8b).

The present invention relates to implementing an anonymous reputation system for managing user reviews, for example reviews of items available for purchase via the internet.

Since 2000, a tremendous effort has been made to improve the state-of-the-art of reputation systems. The aim has been to build the best possible system that helps both consumers and sellers establish mutual trust on the internet. A reputation system allows users to anonymously rate or review products that they bought over the internet, which would help people decide what/whom to trust in this fast emerging e-commerce world.

In 2000, Resnick et al. in their pioneering work [RKZF00] concluded their paper on reputation systems with a comparison to democracy. They suggested that Winston Churchill (British prime minister during WW2) might have said the following: “Reputation systems are the worst way of building trust on the Internet, except for all those other ways that have been tried from time-to-time.” Sixteen years later, Zhai et al., in their interesting work in [ZWCSTF16], are still asking the intriguing and challenging question: “Can we build an anonymous reputation system?” This clearly shows how challenging and difficult it is to build a useful, secure, and deployable reputation system.

Why reputation systems? Because they simulate what used to happen before the internet era; people used to make decisions on what to buy and from whom, based on personal and corporate reputations. However, on the internet, users are dealing with total strangers, and reputation systems seem to be a suitable solution for building trust while maintaining privacy. Privacy has become a major concern for every internet user. Consumers want to rate products that they buy on the internet and yet keep their identities hidden. This is not merely a paranoia; Resnick and Zeckhauser showed in [RZ02] that sellers on eBay discriminate against potential customers based on their review history. This discrimination could take the form of “Sellers providing exceptionally good service to a few selected individuals and average service to the rest'” (as stated in [D00]). Therefore, anonymity seems to be the right property for a reputation system to have. However, on the other hand, we cannot simply fully anonymize the reviews, since otherwise malicious users can for example create spam reviews for the purpose of boosting/reducing the popularity of specific products, thus defeating the purpose of a reliable reputation system. Therefore, reputation systems must also enforce public linkability, i.e. if any user misuse the system by writing multiple reviews or rating multiple times on the same product, he will be detected, and therefore revoked from the system.

Different cryptographic tools have been used to realize reputation systems, including Ring Signatures (e.g. [ZWCSTF16]), Signatures of Reputations (e.g. [BSS10]), Group Signatures (e.g. [BJK15]), Blockchain (e.g. [SKCD16]), Mix-Net (e.g. [ZWCSTF16]), Blind Signatures (e.g. [ACSM08]), etc., each of which improves on one or multiple aspects of reputation systems that are often complementary and incomparable. Other relevant works include a long line of interesting results presented in [D00, JI02, KSG03, DMS03, S06, ACSM08, K09, GK11, CSK13, MK14].

It is an object of the invention to provide an improved implementation of an anonymous reputation system for managing user-submitted reviews.

According to an aspect of the invention, there is provided a computer-implemented method for managing user-submitted reviews of items of goods or services, comprising: maintaining an anonymous reputation system constructed from a group of group signature schemes run in parallel, wherein: each item of a plurality of items of goods or services is associated uniquely with one of the group signature schemes; the anonymous reputation system allows a user to join the group signature scheme associated with the item when the anonymous reputation system receives information indicating that the user has performed a predetermined operation associated with the item; the anonymous reputation system allows the user to submit a review of the item when the user has joined the group signature scheme associated with the item; the anonymous reputation system is publicly linkable, such that where multiple reviews are submitted by the same user for the same item, the reviews are publicly linked to indicate that the reviews originate from the same user; and the anonymous reputation system is configured to be non-frameable, wherein non-frameability is defined as requiring that it is unfeasible for one user to generate a valid review that traces or links to a different user.

Anonymous reputation systems share some of their security properties with group signatures, but require a different and significantly more challenging security model. In particular, anonymous reputation systems need to be publicly linkable, which is not a requirement for group signatures. Adding public linkability changes the way anonymity and non-frameability properties need to be defined relative to the group signature scenario. In can be seen, for example, that public linkability harms the standard anonymity notion for group signatures. In this challenging scenario it has proven difficult to define an acceptable security model even though reputation systems have been a hot topic for the last decade and one of the most promising applications of anonymous digital signatures.

A contribution from the inventors that is embodied in the above-described aspect of the invention is the recognition of a new framing threat that arises when using any linking technique within an anonymous system: namely, the possibility for a malicious user to “frame” another user by generating a review that is accepted by the system but which traces or links to the other user rather than the user who is actually submitting the review.

A further contribution from the inventors lies in the provision of an explicit demonstration that an anonymous reputation system implemented according to the above-described aspect of the invention, which includes a strong security model having at least the defined public linkability and the non-frameability properties, is possible as a practical matter. The inventors have proved in particular that the requirements of the strong security model can in fact be achieved within the framework of an anonymous reputation system constructed from a group of group signature schemes run in parallel.

In an embodiment, the anonymous reputation system is constructed so as to implement security based on lattice-based hardness assumptions rather than number-theoretic hardness assumptions. Implementing security based on lattice-based hardness assumptions greatly increases security against attack from quantum computers. The present disclosure demonstrates that an implementation using lattice assumptions is possible and have proved that the required security properties are achieved when implemented in this way. This proof transforms the theoretical idea of implementing an anonymous reputation system using lattice-based security to a useful practical tool which can actually be used and which will reliably operate as promised, with the promised level of security. An anonymous reputation system has therefore been made available that is now known to be robust not only against the new framing threat discussed above but also against attacks using quantum computing technologies.

In an embodiment, the anonymous reputation system dynamically allows users to join and/or leave at any moment. The present disclosure describes and proves secure implementation of such fully dynamic behaviour for the first time in an anonymous reputation system. The present disclosure provides proof in particular that the non-frameability can be achieved in combination with full dynamicity.

The invention will now be further described, by way of example, with reference to the accompanying drawings, in which:

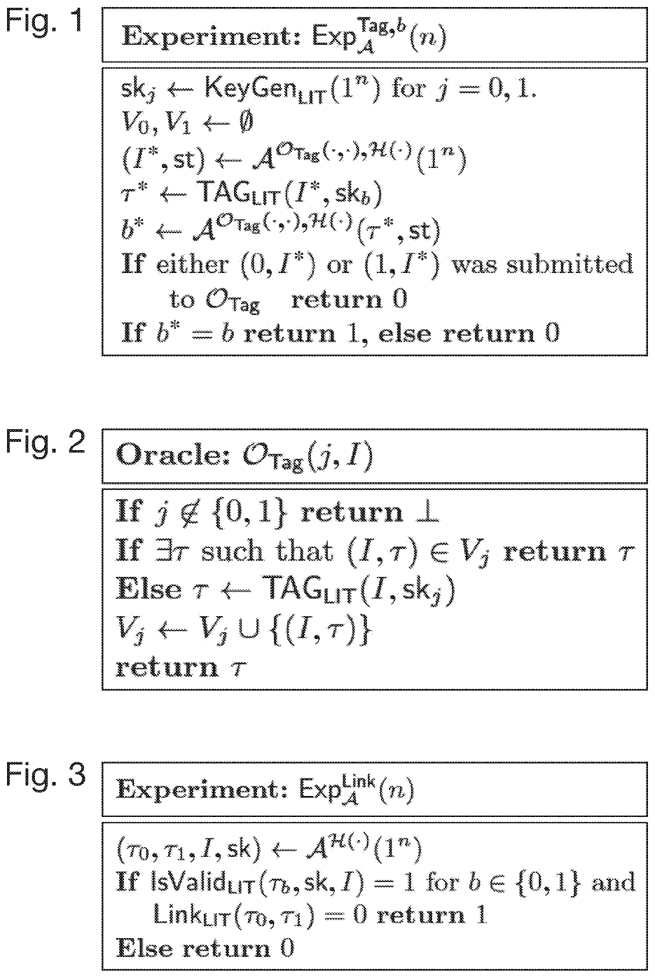

FIG. 1 depicts an experiment defining tag-indistinguishability;

FIG. 2 depicts a description of a tag oracle;

FIG. 3 depicts an experiment defining linkability;

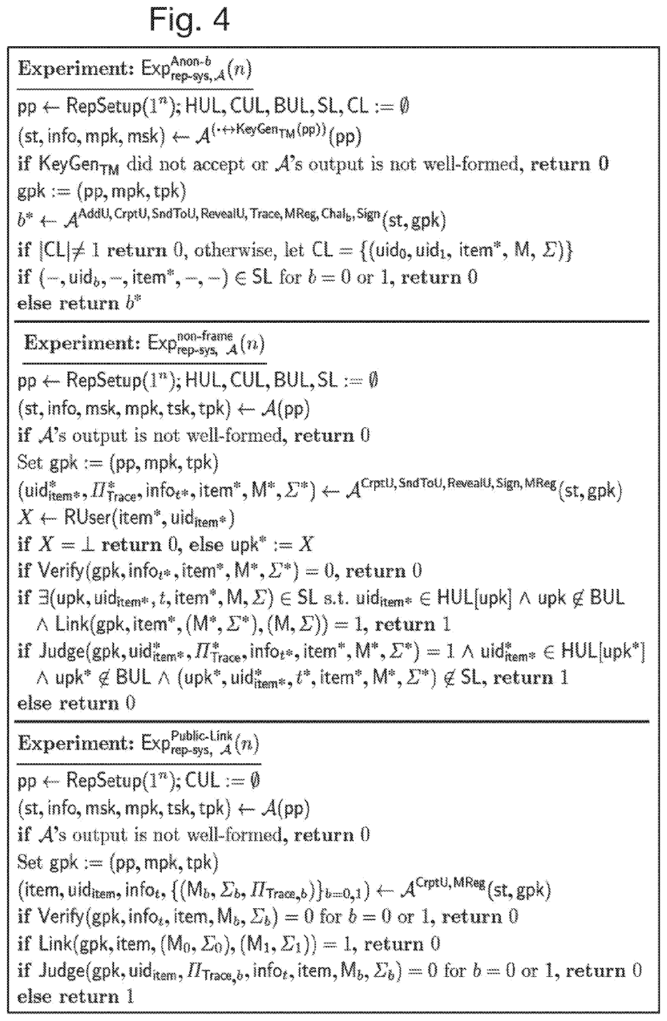

FIG. 4 depicts experiments defining anonymity (top), non-frameability (middle), and public-linkability (bottom);

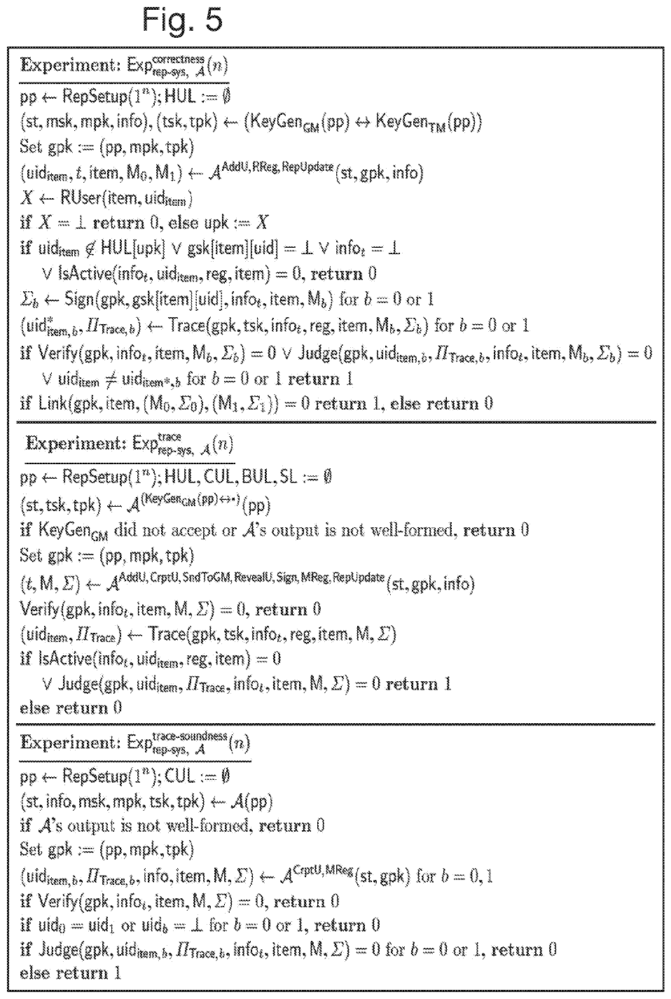

FIG. 5 depicts security experiments for correctness (top), trace (middle) and trace-soundness (bottom);

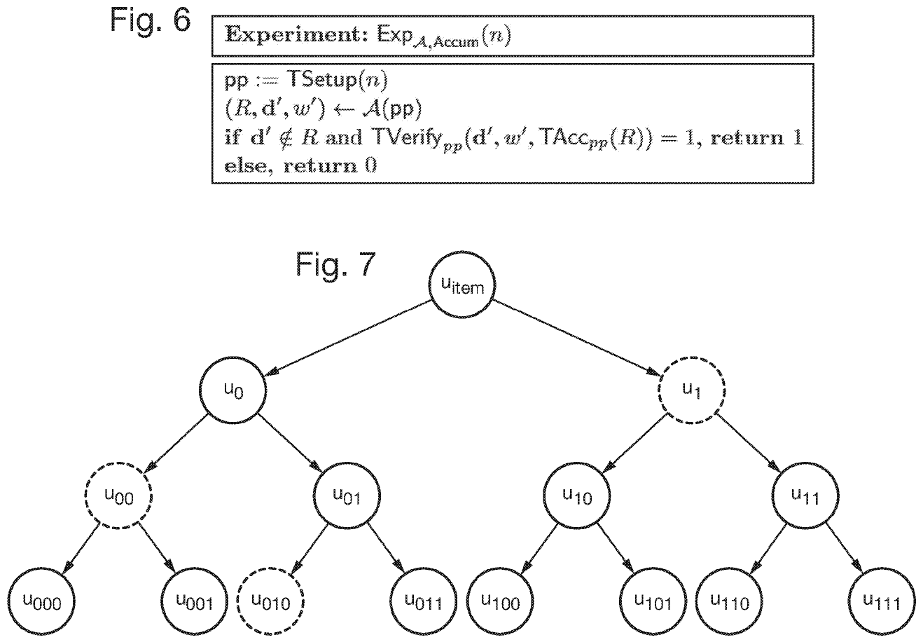

FIG. 6 depicts a security game for accumulators;

FIG. 7 depicts a Merkle-tree for an anonymous reputation system;

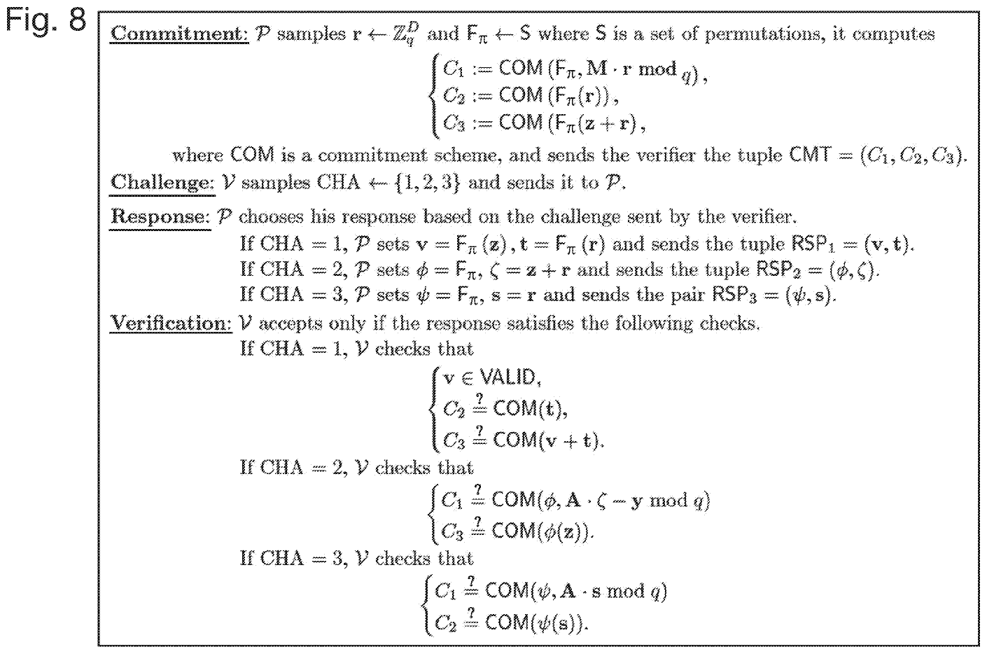

FIG. 8 depicts a Stern-like protocol;

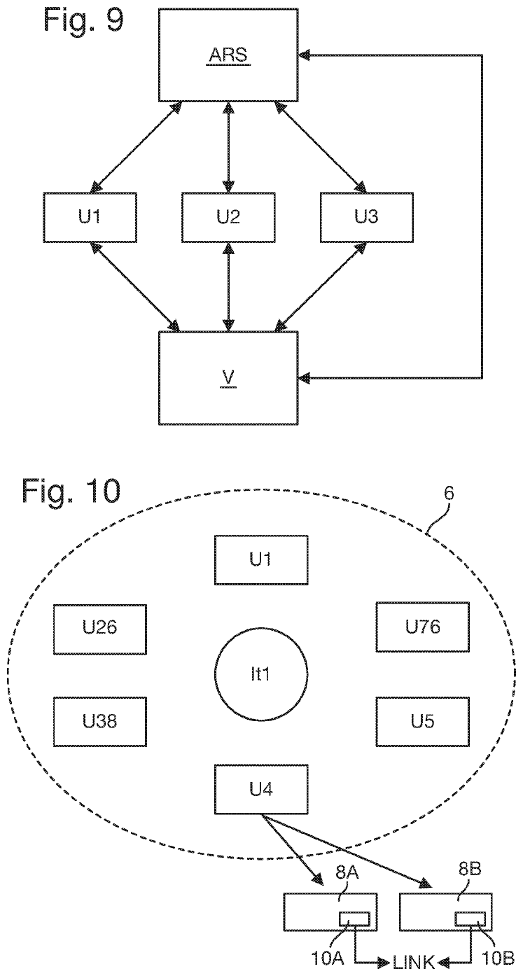

FIG. 9 schematically depicts example interactions between users of an anonymous reputation system, the anonymous reputation system, and an entity from which users can purchase items of goods or services; and

FIG. 10 schematically depicts a group signature scheme associated with an item, users who have purchased the item as members of the group, and an example user who has generated multiple reviews on the same item.

### 1 INTRODUCTION TO DETAILED DESCRIPTION, EXAMPLES AND PROOFS

In the present disclosure, the terms reputation systems and anonymous reputation systems are used interchangeably.

The contribution of the present disclosure includes the following. First, in some embodiments, we strengthen and re-formalize known security models for reputation systems to capture more accurately real-life threats. In particular, our security model captures all possible framing scenarios including when the adversary tries to produce a review that links to another review produced by an honest user. Without this security notion, an adversary can exploit this vulnerability in order to revoke or partially de-anonymize a particular user. Second, in some embodiments, our reputation system is fully dynamic so that users and items can be added and revoked at any time. This is an attractive and should possibly be a default feature for reputations systems to have, since the system manager will not know the users/items in the time of setup of the system. Finally, in some embodiments, we propose the first construction of a reputation system based on lattice assumptions that are conjectured to be resistant to quantum attacks by incorporating a lattice-based tag scheme.

In the present disclosure, we choose to move forward and strengthen the state-of-the-art of reputation systems built from group signatures presented in [BJK15]. Group signatures are considered to be one of the most well-established type of anonymous digital signatures, with a huge effort being made to generically formalize such an intriguing tool (see for instance, [CV91, C97, AT99, BMW03, BBS04, BS04, CG04, BSZ05, BW06, BCCGG16, LNWX17]).

Although anonymous reputation systems share some of their security properties with group signatures, they do have their unique setting that requires a different and more challenging security model. For instance, a unique security property that is required by reputation systems is public-linkability; adding public-linkability will surely effect the way we would define the anonymity and non-frameability properties. For example, public-linkability can be seen to harm the standard anonymity notion for group signatures. Furthermore, a new framing threat arises when using any linking technique within an anonymous system (see details in Section 3.2).

In the present disclosure, we substantially boost the line of work of reputation systems built from group signatures by providing a reputation system that affirmatively addresses three main challenges simultaneously; namely, we give a rigorous security model, achieve full dynamicity (i.e. users can join and leave at any moment), and equip this important topic with an alternative construction to be ready for the emerging post-quantum era.

In an embodiment, we first strengthen and re-formalize the security model for anonymous reputation systems presented in [BJK15] to fully capture all the real-life threats. In particular, we identify a security notion uncalled in the presentation of [BJK15] (although we would like to emphasize that the scheme of [BJK15] is secure according to their formalization, and we do not assert that their scheme is wrong in their proposed security model. We view one of our contributions as identifying a security hole which was not captured by the previous security model for reputation systems [BJK15], and providing a more complete treatment of them by building on the ideas of the most up-to-date security model for group signatures ([BCCGG16]): namely, we capture and formalize the framing scenario where the adversary tries to produce a review that links to another review produced by an honest user. We believe this to be one of the central security notions to be considered in order to maintain a reliable anonymous reputation system, as an adversary otherwise can exploit this vulnerability for the purpose of revoking or partially de-anonymizing a particular user. Also, our security model captures the notion of tracing soundness. It is indeed an important security property as it ensures that even if all parties in the system are fully corrupt, no one but the actual reviewer/signer can claim authorship of the signature. Additionally, in our security model, we are able to put less trust in the managing authorities, namely, the tracing manager does not necessarily have to be honest as is the case with [BJK15]. Second, our reputation system is fully dynamic where users/items can be added and revoked at any time. This is an attractive and should possibly be a default feature for a reputation system to have, due to its dynamic nature, i.e. the system manager will not have the full list of users and items that will be participating in the system upon the setup of the system. Finally, we give a construction of a reputation system that is secure w.r.t our strong security model based on lattice assumptions. To the best of our knowledge, this is the first reputation system that relies on non number-theoretic assumptions, and thereby not susceptible to quantum attacks.

Embodiments of the disclosure comprise computer-implemented methods. The methods may be implemented using any general purpose computer system. Such computer systems are well known in the art and may comprise any suitable combination of hardware (e.g. processors, motherboards, memory, storage, input/output ports, etc.), firmware, and/or software to carry out the methods described. The computer system may be located in one location or may be distributed between multiple different locations. A computer program may be provided to implement the methods when executed by the computer system. The computer program may be provided to a user as a computer program product. The computer program product may be distributed by download or provided on a non-transitory storage medium such as an optical disk or USB storage device.

Computer-implemented methods of the disclosure manage user-submitted reviews of items of goods or services. An example architecture is depicted schematically in FIG. 9. The management of user-submitted reviews is implemented using an anonymous reputation system ARS. The ARS may be implemented using a computer system, as described above. The ARS is thus maintained by a suitably programmed computer system. Users U1-U3 interact with the ARS, for example via a data connection such as the internet, in order to submit reviews about items they have purchased. In the example shown, the users U1-U3 also interact with a vendor server V, for example via a data connection such as the internet, to purchase items that can be subjected to review. The vendor server V processes the purchases and provides purchased items to the users (e.g. via download or traditional postage, depending on the nature of the items being purchased). The nature of the items is not particularly limited. Any item for which a review by a user would be relevant may be used in conjunction with embodiments. The item may be a product or service. When the purchasing procedure is completed with respect to a given user and a given item, the vendor server V informs the computing system running the anonymous reputation system ARS. The anonymous reputation system ARS is thus able to determine when a given user has purchased a given item and can therefore be permitted to write a review about that item. The anonymous reputation system ARS may be maintained at the same location as the vendor server V, optionally using the same computer system, or may be implemented at different locations (as depicted in FIG. 9) using different computer systems.

In some embodiments, the anonymous reputation system ARS is constructed from or comprises a group of group signature schemes run in parallel. The computer system maintaining the ARS may thus run a group of group signature schemes in parallel. Group signature schemes per se are well known in the art. The anonymous reputation system ARS is implemented in such a way that each item of a predetermined plurality of items (which may comprise all items for which reviews are to be managed by the anonymous reputation system ARS) is associated uniquely with one of the group signature schemes of the group of group signature schemes. Reviews associated with the item are managed by the group signature scheme associated with that item. Users can belong to any number of different group signature schemes, according to the number of different items that they have purchased.

As depicted schematically in FIG. 10, the anonymous reputation system ARS allows a user (U1, U76, U5, U4, U38, U26) to join the group signature scheme 6 associated with a particular item It1 when the anonymous reputation system ARS receives information (e.g. from a vendor V, as depicted in FIG. 9) indicating that the user (U1, U76, U5, U4, U38, U26) has performed a predetermined operation associated with the item It1. The predetermined operation may comprise purchasing the item It1 or verifiably experiencing the item It1. In the example of FIG. 9, six users (U1, U76, U5, U4, U38, U26) have purchased the particular item It1 and have therefore been allowed to join the group signature scheme 6 associated with the item It1.

The anonymous reputation system ARS is configured to allow the user (U1, U76, U5, U4, U38, U26) to submit a review of the item It1 when the user has joined the group signature scheme 6 associated with the item It1. The review may be implemented by the user generating a signature corresponding to the group signature scheme, as described in detail below.

The anonymous reputation system ARS is configured so as to be publicly linkable. Public linkability requires that where multiple reviews 8A and 8B are submitted by the same user U4 for the same item It1 as depicted schematically in FIG. 10, the reviews are publicly linked to indicate that the reviews originate from the same user It1. The anonymous reputation system ARS may be configured to detect occurrences of such multiple reviews and take suitable corrective action, such as revoking the user It1 from the group signature scheme or rejecting all but one of the multiple reviews submitted for the same item It1 by the same user U4.

The anonymous reputation system ARS is further configured to be non-frameable. Non-frameability is defined as requiring that it is unfeasible for one user to generate a valid review that traces or links to a different user. Thus, for example, it is not possible for user U5 to generate the reviews 8A and 8B in such a way that they seem to trace back to user U4 when they have in fact been submitted by user U5. It is not possible for a user to “frame” another user in this way, which could lead to honest users being unnecessarily revoked and their legitimate reviews being removed.

In the detailed examples described below, an anonymous reputation system ARS is described which implements security using lattice-based hardness assumptions. Lattice-based hardness assumptions are valid even for attacks using quantum computers. Thus, problems that are considered computationally “hard” (and therefore secure against attack) are hard both for classical computers and quantum computers. This is not necessarily the case where number-theoretic hardness assumptions are made (e.g. based on assuming that certain calculations based on determining factorials are computationally hard). Quantum computers may find such calculations relatively easy and thereby compromise the security of any scheme that is based on such number-theoretic hardness assumptions.

Details about how the security can be implemented using lattice-based hardness assumptions are provided below, together with formal proofs that the approach is possible and works as intended. Some broad features are introduced first here.

In some embodiments, the anonymous reputation system ARS assigns a public key and a secret key to each user. The anonymous reputation system ARS then allows a user to join the group signature scheme 6 associated with an item It1 by assigning a position in a Merkle-tree, the Merkle-tree corresponding to the item It1 in question, and accumulating the public key of the user in the Merkle-tree. The concept of a Merkel-tree is well known in cryptography and computer science. A Merkle-tree may also be referred to as a hash tree. The procedure is described in further detail in Section 4 below.

The anonymous reputation system ARS allows a user U4 to submit a review by generating a signature corresponding to the review by encrypting the assigned position in the Merkle-tree and computing a tag 10A, 10B for the item It1 . In an embodiment, the computed tags 10A, 10B are such as to be extractable from corresponding signatures and usable to determine whether any multiplicity of reviews for the same item It1 originate from the same user U4. If, as in FIG. 10, a user U4 attempts to write multiple reviews for a given item It1, the tags 10A,10B will thus behave in a certain way, for example similarly or identically, if the user U4 and item It1 are the same for the multiple reviews. In some embodiments, the tags 10A and 10B will be identical. In the context of a lattice-based implementation such as that described in detail below, the computed tags 10A, 10B may be represented by vectors. In such embodiments, the deter mination of whether any multiplicity of reviews for the same item It1 originate from the same user U4 may comprise determining a degree of similarity between the multiple computed tags 10A, 10B. In an embodiment, the degree of similarity relates to similarity of mathematical behaviour. In an embodiment, the degree of similarity is determined based on whether a distance or difference between the computed tags is bounded by predetermined scalar.

In some embodiments, the anonymous reputation system ARS dynamically allows users to join and/or leave at any moment. The anonymous reputation system ARS is thus a fully dynamic system rather than a static system. In the context of a lattice-based implementation such as that described in detail below, this fully dynamic behaviour may be made possible via the update mechanism for the Merkle-tree (which allows users to join group signature schemes associated with items when they purchase those items) introduced above and discussed in further detail below. The discussion below also provides proof that the non-frameability can be achieved in combination with the full dynamicity.

In some embodiments, the maintaining of the anonymous reputation system comprises implementing a Group Manager (GM). The GM uses GM keys to generate tokens to users to allow the users to submit reviews. The GM may be thought of as a system manager, i.e. the entity (or entities working in collaboration, as this can be generalised to have multiple managers in order to enforce decentralisation) that manages the whole reviewing system. In some embodiments, in order to enforce a proper separation of duties, a separate entity called a Tracing Manager (TM) is also implemented. The TM may be thought of as a “troubleshooting manger” that is only called to troubleshoot the system in case of misuse/abuse. The TM may use TM keys to review the identity of a user who has a written a particular review in case of any misuse/abuse of the system.

### 2 Preliminaries

### 2.1 Lattices

For positive integers n, m such that n≤m, an integer n-dimensional lattice Λ in [symbol] ^{m} is a set of the form {Σ_{i∈[n]}χᵢbᵢ|χᵢ ∈ [symbol] }, where B={b₁, . . . , Bₙ} are n linearly independent vectors in [symbol] ^{m}. Let [symbol] , σ be the discrete Gaussian distribution over [symbol] ^{m} with parameter σ>0. In the following, we recall the definition of the Short Integer Solution (SIS) problem and the Learning with Errors (LWE) problem.

Definition 1 (SIS). For integers n(λ),m=m(n), q=q(n)>2 and α positive real β, we define the short integer solution problem SIS_{n,m,q,β}as the problem of finding a vector x ∈ [symbol] ^{m} such that Ax=0 mod q and ∥x∥∞≤β when given A← [symbol] _{q}^{n×m} m as input.

When m,β=poly(n) and q>\sqrt{n}β, the SIS_{n,m,q,β}problem is at least as hard as SIVP_{γ}for some γ=β·Õ(\sqrt{nm}). See [GPV08, MP13].

Definition 2 (LWE). For integers n=n(λ),m=m(n), t=t(n), a prime integer q=q(n)>2 such that t<n and an error distribution over χ=χ⁽ⁿ⁾ over [symbol] we define the decision learning with errors problem LWE_{n,m,q,χ}as the problem of distinguishing between (A, A^{T}s+x) from (A, b), where A← [symbol] _{q}^{n×m}, s←χⁿ, x←χ^{m} and b← [symbol] _{q}^{m}. We also define the search first-are-errorless learning with errors problem faeLWE_{n,t,m,q,χ}as the problem of finding a vector s∈ [symbol] _{q}ⁿ when given b=A^{T}s+x mod q as input, where A← [symbol] _{q}^{n×m}, s←χⁿ and x←{0}^{t}×χ^{m-t}, i.e., the first t samples are noise-free.

[ACPS09] showed that one can reduce the standard LWE problem where s is sampled from [symbol] _{q}ⁿ to the above LWE problem where the secret is distributed according to the error distribution. Furthermore, [ALS16] showed a reduction from LWE_{n-t,m,q,χ}to faeLWE_{n,t,m,q,χ}that reduces the advantage by at most 2^{n-t-1}. When χ= [symbol] and αq>2\sqrt{2n}, the LWE_{n,m,q,χ}is at least as (quantumly) hard as solving SIVP_{γ}for some γ=Õ(n/α). See [Reg05, Pei09, BLP⁺13]. We sometimes omit the subscript m from LWE_{n,m,q,χ}, faeLWE_{n,m,q,X},χ, since the hardness of the problems hold independently from m=poly(n). In the following, in case χ=D [symbol] _{,β}, we may sometimes denote LWE_{n,m,q,β}, faeLWE_{n,m,q,β}.

### 2.2 Tag Schemes

We recall here the lattice-based linkable indistinguishable tag (LWE-LIT) scheme presented in [EE17]. Let m,w,q be positive integers with m=3w and q>2 a prime. Assume they are all implicitly a polynomial function of the security parameter n, where we provide a concrete parameter selection in our construction (See Section 4). Let [symbol] : {0, 1}*→ [symbol] _{q}^{m×w} be a hash function modeled as a random oracle in the security proofs. Let [symbol] = [symbol] Z_{q}^{m}∩[−β,β]^{m} be the key space for some positive integer β<q, [symbol] = [symbol] _{q}^{m} be the tag space, and [symbol] ={0, 1}* be the message space. Finally, let β′ be some positive real such that β>β′w(\sqrt{log n}). Then, the lattice-based linkable indistinguishable tag scheme is defined by the following three PPT algorithms LIT=(KeyGen_{LIT}, TAG_{LIT}, Link_{LIT}):

KeyGen_{LIT}(1ⁿ): The key generation algorithm takes as input the security parameter 1ⁿ, it samples a secret key sk← [symbol] ,_{β′}until sk∈ [symbol] ¹. It then outputs sk. ¹ The expected number of samples required will be a constant due to our parameter selection. In particular, we have Pr[|χ|>β′w(\sqrt{log n})]=negl(n) for χ← [symbol] .

TAG_{LIT}(I, sk): The tag generation algorithm takes as input a message I∈ [symbol] and a secret key sk∈ [symbol] , and samples an error vector e← [symbol] ,_{β′}. It then outputs a tag [symbol] = [symbol] (I)^{T}sk=e ∈ [symbol] .

Link_{LIT}( [symbol] ): The linking algorithm takes as input two tags [symbol] , and outputs 1 if ∥ [symbol] ∥∞≤2βand 0 otherwise.

We require one additional algorithm only used during the security proof.

IsValid_{LIT}( [symbol] sk, I): This algorithm takes as input a tag [symbol] , a secret key sk and a message I, and outputs 1 if ∥ [symbol] (I)^{T}sk∥∞≤β and 0 otherwise.

The tag scheme (LIT) must satisfy two security properties, namely, the tag-indistinguishability and linkability. Informally speaking, tag-indistinguishability ensures that an adversary [symbol] cannot distinguish between two tags produced by two users (of his choice) even given access to a tag oracle. Linkability means that two tags must “link” together if they are produced by the same user on the same message. In the context of reputation systems, the messages associated to the tag will correspond to the items that the users buy. Therefore, when the users write two anonymous reviews on the same item, the tags will help us link the two reviews.

Tag-indistinguishability. A tag-indistinguishability for a LIT scheme is defined by the experiment in FIG. 1. We define the advantage of an adversary [symbol] breaking the tag-indistinguishability as follows:

[symbol]

(n)=|Pr[ [symbol] (n)=1]−Pr[ [symbol] (n)=1]|

We say that a LIT scheme is tag-indistinguishable if for all polynomial time adversary [symbol] the advantage is negligible.

The proof of the following Theorem 1 is provided in Appendix A.

Theorem 1 (tag-indistinguishability). For any efficient adversary [symbol] against the tag-indistinguishability experiment of the LWE-LIT scheme as defined above, we can construct an efficient algorithm [symbol] solving the LW [symbol] problem with advantage:

[symbol]

(n)≥ [symbol] (n)−negl(n),

where Q denotes the number of random oracle queries made by [symbol] . In particular, assuming the hardness of LW [symbol] , the advantage of any efficient adversary [symbol] is negligible.

Linkability. A linkability of a LIT scheme is defined by the experiment in FIG. 3. We define the advantage of an adversary [symbol] breaking the linkability as [symbol] (n)=Pr[ [symbol] (n)=1]. We say that a LIT scheme is non-linkable if for all adversary [symbol] the advantage is negligible.

Theorem 2 (Linkability). For any adversary [symbol] against the linkability experiment of the LWE-LIT scheme as defined above, the advantage [symbol] (n) is negligible.

Proof. Suppose, towards a contradiction, that all adversary α wins the linkability experiment. In particular, [symbol] outputs ( [symbol] ₀, [symbol] ₁,I,sk) such that the following three conditions hold: ∥ [symbol] ₀− [symbol] (I)^{T}sk∥≤β,∥ [symbol] ₁− [symbol] (I)^{T}sk∥≤β, and ∥ [symbol] ∥>β. From the first two inequalities, we have

∥ [symbol] ∥=∥( [symbol] ₀− [symbol] (I)^{T}sk)+( [symbol] ₁− [symbol] (I)^{T}sk∥≤∥ [symbol] ₀− [symbol] (I)^{T}sk∥+∥ [symbol] ₁− [symbol] (I)^{T}sk∥≤2β,

by the triangular inequality. However, this contradicts the third inequality.

### 2.3 Group Signatures

In a group signature, a group member can anonymously sign on behalf of the group, and anyone can then verify the signature using the group's public key without being able to tell which group member signed it. A group signature has a group manager who is responsible for generating the signing keys for the group members. There arc two types of group signatures; the static type [BMW03] where the group members are fixed at the setup phase. In this case, the group manager can additionally trace a signature and reveal which member has signed it. The second type is the dynamic type [BSZ05, BCC⁺16], where users can join/leave the system at anytime. Now a group has two managers; the group manager and a separate tracing manager who can open signatures in case of misuse/abuse. Briefly speaking, a group signature has three main security requirements; anonymity, non-frameability, and traceability. Anonymity ensures that an adverary cannot tell which group member has signed the message given the signature. Non-frameability ensures that an adversary cannot produce a valid signature that traces back to an honest user. Finally, traceability ensures that an adversary cannot produce a valid signature that does not trace to an any user. In our work, we build on the recent lattice-based fully dynamic group signature scheme of [LNWX17] to construct our reputation system. We briefly sketch how the group signature scheme of [LNWX17] works; a group manager maintains a Merkle-tree in which he stores members' public keys in the leaves where the exact position are given to the signers at join time. The leaves will be hashed to the top of the tree using an accumulator instantiated using a lattice-based hash function (see details in Appendix D). The relevant path to the top of the tree will be given to each member where the top of the tree itself is public. In order to sign, a group member has to prove in zero-knowledge that; first, he knows the pre-image of a public key that has been accumulated in the tree, and that he also knows of a path from that position in the tree to its root. Additionally, they apply the Naor-Yung double-encryption paradigm [NY90] with Regev's LWE-based encryption scheme [Reg05] to encrypt the identity of the signer (twice) w.r.t the tracer's public key to prove anonymity. To summarize, a group signature would be of the form (II, c₁, c₂), where II is the zero-knowledge proof that the signer is indeed a member of the group (i.e., his public key has been accumulated into the Merkle-tree), and the encrypted identity in both c₁ and c₂ is a part of the path that he uses to get to the root of the Merkle-tree. Note that this implies that the ciphertexts (c₁, c₂) are bound to the proof II.

### 3 Syntax and Security Definitions

We formalize the syntax of reputation systems following the sate-of-the-art formalization of dynamic group signatures of [BCC⁺16]. We briefly explain the two major differences that distinguish between a reputation system from a group signature scheme. First, a reputation system is in essence a group of group signature schemes run in parallel, where we associate each item uniquely to one instance of the group signature scheme. Second, we require an additional algorithm Link in order to publicly link signatures (i.e., reviews), which is the core functionality provided by reputation systems. We now define reputation systems by the following PPT algorithms:

RepSetup(1ⁿ)→pp: On input of the security parameter 1ⁿ, the setup algorithm outputs public parameters pp.

KeyGen_{GM}(pp)↔KeyGen_{TM}(pp): This an interactive protocol between the group manager GM and the tracing manager TM. If completed successfully, KeyGen_{GM} outputs the GM's key pair (mpk, msk) and KeyGen_{TM} outputs the TM's key pair (tpk, tsk). Set the system public key to be gpk:=(pp, mpk,tpk).

UKgen(1n)→(upk, usk): On input of the security parameter 1ⁿ, it outputs a key pair (upk, usk) for a user. We assume that the key table containing the various users' public keys upk is publicly available.

Join(infoₜ_{_{current}}, gpk, upk, usk, item)↔Issue(infoₜ_{_{current}}, msk, upk, item): This is an interactive protocol between a user upk and the GM. Upon successful completion, the GM issues an identifier uidᵢₜₑₘ associated with item to the user who then becomes a member of the group that corresponds to item². The final state of the Issue algorithm, which would always include the user public key upk, is stored in the user registration table reg at index (item, uidᵢₜₑₘ) which is made public. Furthermore, the final state of the Join algorithm is stored in the secret group signing key gsk[item][uidᵢₜₑₘ]. ² Here our syntax assumes that the items to be reviewed have been already communicated to the GM from the respective service providers. We merely do this to make our presentation simple and we emphasize that our construction is general in the sense that the GM does not need to know neither the number of items nor the items themselves ahead of time. Items can dynamically be added/removed from the system by GM when it is online.

RepUpdate(gpk, msk, R, infoₜ_{_{current}}, reg)→(infoₜ_{_{new}}, reg): This algorithm is run by the GM to update the system info. On input of the group public key gpk, GM's secret key msk, a list R of active users' public keys to be revoked, the current system info infoₜ_{_{current}}, and the registration table reg, it outputs a new system info infoₜ_{_{new}} while possibly updating the registration table reg. If no changes have been made, output ⊥.

Sign(gpk, gsk[item][uidᵢₜₑₘ], infoₜ_{_{current}}, item, M)→Σ: On input of the system's public key gpk, user's group signing key gsk[item][uidᵢₜₑₘ], system infoₜ_{_{current}} at epoch t_{current}, an item, and message M, it outputs a signature Σ. If the user owning gsk[item][uidᵢₜₑₘ] is not an active member at epoch t_{current}, the algorithm outputs ⊥.

Verify(gpk, infoₜ_{_{current}}, item, M, Σ)→1/0: On input of the system's public key gpk, system info infoₜ_{_{current}}, an item, a message M, and a signature Σ, it outputs 1 if Σ is valid signature on M for item at epoch t_{current}, 0 otherwise.

Trace(gpk, tsk, infoₜ_{_{current}}, reg, item, M, Σ)&43 (uidᵢₜₑₘ, II_{Trace}): On input of the system's public key gpk, the TM's secret key tsk, the system information infoₜ_{_{current}}, the user registration table reg, an item, a message M, and a signature Σ, it outputs the identifier of the user uidᵢₜₑₘ who produced Σ and a proof II_{Trace} that attests to this fact. If the algorithm cannot trace the signature to a particular group member, it returns ⊥.

Judge(gpk, uidᵢₜₑₘ, II_{Trace}, infoₜ_{_{current}}, item, M, Σ)1/0: On input of the system's public key gpk, a user's identifier uidᵢₜₑₘ, a tracing proof II_{Trace} from the Trace algorithm, the system info infoₜ_{_{current}}, an item, a message M and signature Σ, it outputs 1 if II_{Trace} is a valid proof that uidᵢₜₑₘ produced Σ and 0 otherwise.

Link(gpk, item, (m₀, Σ₀),(m₁, Σ₁))→1/0: On input of the system's public key gpk, an item, and two message-signature pairs, it returns 1 if the signatures were produced by the same user on behalf of the group that corresponds to item, 0 otherwise.

IsActive(infoₜ_{_{current}}, uidᵢₜₑₘ, reg, item)→1/0: this algorithm will only be used in the security games. On input of the system infoₜ_{_{current}}, a user's identifier uidᵢₜₑₘ, the user registration table reg, and an item, it outputs 1 if uidᵢₜₑₘ is an active member of the group for item at epoch t_{current} and 0 otherwise.

### 3.1 Discussion on the Security Model of FC′15 Reputation System

Blömer et al. [BJK15] constructed an anonymous reputation system from group signatures based on number-theoretical assumptions. In their work, they claim to formalize reputation systems following the formalization of partially dynamic group signature schemes presented by Bellare et al. [BSZ05], i.e., they have two managers, the group manger and key issuer³. However, one can notice that the security model is in fact strictly weaker than that of [BSZ05]; the major difference being the assumption that the opener/tracer is always honest. Furthermore, in their public-linkability property, the key issuer (the GM in our case) is assumed to be honest. Another observation, which we believe to be of much bigger concern, is that their security notion for reputation systems does not fully capture all the real-life threats. In particular, their strong-exculpability property (which is essentially the notion of non-frameability), does not capture the framing scenario where the adversary outputs a signature that links to an honest user; it only captures the scenario where the adversary outputs a signature that traces to an honest user. Note that the former attack scenario does not exist in the context of group signatures since no tag schemes are being used there, i.e., the whole notion of linkability does not exist. However, it is a vital security requirement in the reputation system context as an adversary could try to generate a review that links to an honest user's review so that the GM may decide to revoke or de-anonymize the honest user. In our work, we provide a formal definition of reputation systems that models more accurately these real-life threats, which in particular, solve the aforementioned shortcomings of [BJK15]. ³ Note that [BJK15] does not completely follow the notation used in [BSZ05], i.e., their group manager is in fact the tracer in [BSZ05].

### 3.2 Security Definitions

We provide a formal security definition following the experiment type definition of [BCC⁺16, LNWX17] for fully dynamic group signatures, which originates to [BSZ05]. Anonymity, non-frameability and public-linkability are provided in FIG. 4, and the rest are provided in FIG. B.1. The oracles used during the security experiments are provided in Appendix B. One of the main differences between theirs and ours is that, we require the public-linkability property, which does not exist in the group signature setting. Moreover, the existence of the tag scheme further affects the anonymity and non-frameability properties, which are depicted in FIG. 4; for the former, an adversary should not be allowed to ask for signatures by the challenge users on the challenge item, otherwise he could trivially win the game by linking the signatures. In the latter, an additional attack scenario is taken into consideration, i.e., when an adversary outputs a review that links to an honest user's review. the game. Also, our public linkability holds unconditionally, and therefore, GM can be assumed to be corrupt there. We now present the security properties of our reputation system.

Correctness A reputation system is correct if reviews produced by honest, non-revoked users are always accepted by the Verify algorithm and if the honest tracing manager can always identify the signer of such signatures where his decision will be accepted by a Judge. Additionally, two reviews produced by the same user on the same item should always link.

Anonymity A reputation system is anonymous it for any PPT adversary the probability of distinguishing between two reviews produced by any two honest signers is negligible even if the GM and all other users are corrupt, and the adversary has access to the Trace oracle.

Non-frameability A reputation system is non-frameable if for any PPT adversary it is unfeasible to generate a valid review that traces or links to an honest user even if it can corrupt all other users and chose the keys for GM and TM.

Traceability A reputation system is traceable if for any PPT adversary it is infeasible to produce a valid review that cannot be traced to an active user at the chosen epoch, even if it can corrupt any user and can choose the key of TM⁴. ⁴ The group manager GM is assumed to be honest in this game as otherwise the adversary could trivially win by creating dummy users.

Public-Linkability A reputation system is publicly linkable if for any (possibly inefficient) adversary it is unfeasible to output two reviews for the same item that trace to the same user but dose not link. This should hold even if the adversary can chose the keys of GM and TM.

Tracing Soundness A reputation system has tracing soundness if no (possibly inefficient) adversary can output a review that traces back to two different signers even if the adversary can corrupt all users and chose the keys of GM and TM.

### 4 Our Lattice-Based Reputation System

Intuition behind our scheme. It is helpful to think of our reputation system as a group of group signatures managed by a global group manager (or call it a system manager), whom we refer to as a group manager GM for simplicity. This group manager shares the managerial role with the tracing manager TM who is only called for troubleshooting, i.e., to trace users who misused the system. The group manager maintains a set of groups, each corresponds to a product/item owned by a certain service provider. Users who bought a certain item are eligible to become a member of the group that corresponds to this item, and can therefore write one anonymous review for this item. Every user in the system will have his own pair of public-secret key (upk, usk). When he wants to join the system for a particular item, he would engage in the Join-Issue protocol with GM. after which, he would be assigned a position uid=bin(j)∈{0,1} [symbol] in the Merkle-tree that corresponds to the item in question, and his public key will be accumulated in that tree. Here, j (informally) denotes the j-th unique user to have bought the corresponding item. The user can now get his witness wⱼ that attests to the fact that he is indeed a consumer of the item, on which he is then ready to write a review for that item. Technically speaking, he needs to provide a non-interactive zero-knowledge argument of knowledge for a witness to the following relation [symbol] _{Sign}:

R_{Sign}={(A, u, z,69 _{Tag}(item ), [symbol] , c₁, c₂, B, P₁, P₂), (p, wⱼ, x, e, uidᵢₜₑₘ, r₁, r₂): p≠0^{nk}∧TVerify_{A}(p,wⱼ,u)=1∧A·x=G·p mod q ∧(Enc_{Regev}((B,P₁,P₂),uidᵢₜₑₘ;(r₁,r₂))=(c₁,c₂)∧ [symbol] = [symbol] _{Tag(item)}^{T}x+e}.

As it can be seen, the signer encrypts his uid and computes a tag for the item in question. This tag ensures that he can only write one review for each item, otherwise his reviews will be publicly linkable and therefore detectable by GM. Regarding the verification, anyone can then check the validity of the signature by simply running the verify algorithm of the underlying NIZKAoK proof system. In any misuse/abuse situation, TM can simply decrypt the ciphertext attached to the signature to retrieve the identity of the signer. TM also needs to prove correctness of opening (to avoid framing scenarios) via the generation of a NIZKAoK for the following relation [symbol] _{Trace}:

R_{Trace}={(c₁,c₂,uidᵢₜₑₘ, B,P₁),(S₁,E₁):Dec_{Regev}((S₁,E₁),(c₁,c₂))=uidᵢₜₑₘ}

Finally, for public linkability, we require that any two given signatures (Σ₀, Σ₁) for the same item can be publicly checked to see if they are linkable, i.e., check that were produced by the same reviewer. This can be done simply by feeding the tags [symbol] and [symbol] of the two signatures, to the Link_{LIT} algorithm of the underlying LIT scheme. If Link_{LIT} returns 0, then Σ₀ and Σ₁ were not produced by the same user, and therefore are legitimate reviews from two different users. Otherwise, in the case it returns 0, we know that some user reviewed twice for the same item; the GM asks TM to trace those signatures and find out who generated them and GM will then revoke the traced user from the system.

### 4.1 Our Construction

Underlying Tools. In our construction, we use the multi-bit variant of the encryption scheme of Regev [KTX07, PVW08] provided in Appendix D.4, which we denote by (KeyGen_{Regev}, Enc_{Regev}, Dec_{Regev}). We also employ the lattice-based tag scheme (KeyGen_{LIT}, TAG_{LIT}, Link_{LIT}) provided in Section 2.2. We assume both scheme share the same noise distribution χ (See below). We also use a lattice-based accumulator (TSetup, TAcc_{A}, TVerify_{Δ}, TUpdate_{Δ}) provided in Appendix D.3. Finally, we use a Stern-like zero-knowledge proof system provided in Appendix E.2, where the commitment scheme of [KTX08] is used internally.

Construction. The proposed reputation system consists of the following PPT algorithms:

RepSetup(1ⁿ): On input of the security parameter 1ⁿ, it outputs the public parameters,

pp=(N,n,q,k,m,m_{E};w, [symbol] ,β,χ,κ, [symbol] _{Tag}, [symbol] _{Sign}, [symbol] _{Trace}, A).

Where, N= [symbol] =poly(n) is the number of potential users, q= [symbol] (n^{1.5}), k=[log₂q], m=2nk, m_{E}=2(n+ [symbol] )k,w=3m,β=\sqrt{n}·w(log n), and a β/\sqrt{2}-bounded noise distribution χ. Moreover, [symbol] _{Tag}: {0,1}*→ [symbol] _{q}^{m×w} is the hash function used for the tag scheme, and [symbol] _{Sign}, [symbol] _{Trace}:{0,1}*→{1, 2, 3}^{κ}are two hash functions used for the NIZKAoK proof systems for [symbol] _{Sign} and [symbol] _{Trace}, where κ=w(log n). Finally, A← [symbol] _{q}^{n×m}.

KeyGen_{GM}(pp)↔KeyGen_{TM}(pp): This is for the group manager and tracing manager to set up their keys and publish the system's public information. The group manager samples msk←{0,1}^{m}, and sets mpk:=A·msk mod q. On the other hand, TM runs (pk_{Enc},sk_{Enc})←KeyGen_{Regev}(1ⁿ) and sets tpk:=pk_{Enc}=(B, P₁, P₂) and tsk:=sk_{Enc}=(S₁, E₁). GM receives tpk from TM and creates an empty reg table. Namely, reg[item][bin(j)][1]=0^{nk} and reg[item][bin(j)][2]=0 for j=1, . . . ,N−1 and all item in the system, i.e., it is epoch 0 and no users have joined the system yet⁵. Here, GM maintains multiple local counters cᵢₜₑₘ to keep track of the registered users for each item, which are all set initially to 0. Finally, GM outputs gpk=(pp, mpk, tpk) and info=∅. ⁵ Recall that for simplicity of presentation, we assume the all items are provided to the GM. Our scheme is general enough so that the items can dynamically be added/removed from the system by GM.

UKgen(1ⁿ): This algorithm is run by the user. It samples x←KeyGen_{LIT}(1ⁿ) where x∈[−β, β]^{m} and sets usk:=x. It then computes upk:=p=bin(Ax mod q)∈{0,1}^{nk}. Hereafter, the user is identified by his public key upk.

Join↔Issue: A user (upk, usk)=(p, x) requests to join the group that corresponds to item at epoch t. He sends p to GM. If GM accepts the request, it issues an identifier for this user, i.e., uidᵢₜₑₘ=bin(cᵢₜₑₘ)∈{0,1 [symbol] . The user's signing key for item is then set to gsk[uidᵢₜₑₘ][item]=(uidᵢₜₑₘ, p, x). Now, GM updates the Merkle tree via TUpdate_{item,A}(uidᵢₜₑₘ, p)₆, and sets reg[item][uidᵢₜₑₘ][1]:=p, reg[item][uidᵢₜₑₘ][2]:=t. Finally, it increments the counter cᵢₜₑₘ:=cᵢₜₑₘ+1. ⁶ See details in Section D.3.

RepUpdate(gpk, msk, R, infoₜ_{_{current}}, reg): This algorithm is be run by GM. Given a set R of users to be revoked, it first retrieves all the uidᵢₜₑₘ associated to each upk=p∈R. It then runs TUpdate_{item,A}(reg[item][uidᵢₜₑₘ][1],0^{nk}) for all the retrieved uidᵢₜₑₘ. It finally recomputes uₜ_{_{new}},ᵢₜₑₘ and publishes

info_{new}={(uₜ_{_{new,}}ᵢₜₑₘ , Wᵢₜₑₘ)}ᵢₜₑₘ,

where, Wᵢₜₑₘ={w_{i,item}}ᵢ and w_{i,item}∈{0, 1} [symbol] ×({0, 1}^{nk}) [symbol] is the witness that proves that upkᵢ=pᵢ is accumulated in uₜ_{_{new,}}ᵢₜₑₘ. Here, the first [symbol] -bit string term of the witness refers to the user identifier uidᵢₜₑₘ associated to item.

Sign(gpk,gsk[item][uidᵢₜₑₘ],infoₜ_{_{current}},item, M): If infoₜ_{_{current}} does not contain a witness w_{i,item} with the first entry being uidᵢₜₑₘ∈{0, 1} [symbol] , return ⊥. Otherwise, the user downloads uₜ_{_{current,item}} and his witness w_{i,item} from infoₜ_{_{current}}. Then, it computes (c₁, c₂)←Enc_{Regev} (tpk, uidᵢₜₑₘ) and the tag [symbol] ←TAG_{LIT}(item,x), where recall usk=x. Finally, it generates a NIZKAoK II_{sign}=({CMTᵢ}ᵢ₌₁ [symbol] , CH, {RSP}ᵢ₌₁ [symbol] ) for the relation R_{Sign}, where

CH= [symbol] _{Sign}(M,{CMTᵢ}ᵢ₌₁ [symbol] , A, u, [symbol] _{Tag}(item), [symbol] ,c₁,c₂,B,P₁, P₂)∈{1,2,3}^{z,24} ,

and outputs the signautre Σ=(II_{Sign,} [symbol] _{,c}_{₁}_{, c}_{₂}).

Verify(gpk,infoₜ_{_{current}},item,M,Σ): It verifies if II_{Sign} is a valid proof. If so it outputs 1 and otherwise it outputs 0.

Trace(gpk, tsk, infoₜ_{_{current}},reg,item,M,Σ): It first runs uidᵢₜₑₘ←Dec_{Regev}((S₁,E₁,(c₁, c₂)). Then, it generates a NIZAoK proof II_{Trace} for the relation R_{Trace}.

Judge(gpk,uidᵢₜₑₘ,II_{Trace},infoₜ_{_{current}},item,M,Σ): It verifies if II_{Trace} is a valid proof. If so it outputs 1 and otherwise it outputs 0.

Link(gpk,item,(M₀,Σ₀),(M₁,Σ₁)): It parses Σ₀ and Σ₁ and outputs b←Link_{LIT}( [symbol] ), where b=1 when it is linkable and 0 otherwise.

### 4.2 Security Analysis

We show that our reputation system is secure. Each of the following theorems correspond to the security definitions provided in Section 3.2, except for the correctness which can be easily checked to hold. Here, we only provide the high-level overview of some of the proofs that we believe to be of interest, and omit the formal proofs to Appendix C. The parameters that appear in the theorems are as provided in the above construction.

Theorem 3 (Anonymity). Our reputation system is anonymous, assuming the hardness of the decision LWE_{n,q,x} problem.

Proof Overview. We proceed in a sequence of hybrid experiments to show that [symbol] (n)− [symbol] (n)|≤neg|for any PPT algorithm. The high level strategy is similar to the anonymity proof for the dynamic group signature scheme provided in [LNWX17], Lemma 2. Namely, for the challenge signature, we swap the user identifier uidᵢₜₑₘ embedded in the ciphertexts (c₁,c₂) and the user's secret key usk embedded in th tag [symbol] . The main difference between the proof of [LNWX17] is that for our reputation system we have to swap the tag in the challenge signature. For this, we use the tag indistinguishability property of the underlying tag scheme LWE-LIT presented in Theorem 1. This modification in the experiments are provided in Exp₅ of our proof.

Theorem 4 (Non-Frameability). Our Reputation System is non-frameable, assuming the hardness of the SIS_{n,m,q,1} problem of the search faeLWE_{m,n,q,χ}(or equivalently the search LWE_{m-n,q,χ}) problem.

Proof Overview. For an adversary to win the experiment, he must output a tuple (uid*_{item*},II*_{Trace},info_{t*},item*,M*,Σ*) such that (informally): (i) the pair (M*,Σ*) links to some other message-signature pair (M,Σ) corresponding to item* of an honest non-corrupt user or (ii) the proof II*_{Trace} traces the signature Σ* back to some honest non-corrupt user. Since the latter case (ii) essentially captures the non-frameability of fully dynamic group signatures, the proof follows similarly to [LNWX17], Lemma 3. However, for case (i), we must use a new argument, since this is a security notion unique to reputation systems. In particular, we aim to embed a search LWE problem into the tag of the message-signature pair (M,Σ) of an honest non-corrupt user (where the simulator does not know the secret key usk) for which the adversary outputs a linking signature forgery (M*,Σ*). Due to the special nature of our LWE tag scheme, we can prove that if the signatures link, then the two secret keys usk, usk* embedded in the tags must be the same. Therefore, by extracting usk* from the adversary's forgery, we can solve the search LWE problem. However, the problem with this approach is that since the simulator does not know usk, he will not be able to provide the adversary with this particular user's public key upk, which is defined as A·usk mod q. Our final idea to overcome this difficulty is by relying on the so called first-are-error-less LWE problem [BLP⁺13, ALS16], which is proven to be as difficult as the standard LWE problem. Namely, the simulator will be provided with A·usk as the error-less LWE samples and uses the remaining non-noise-less LWE samples to simulate the tags.

Theorem 5 (Public Linkability). Our reputation system is unconditionally public-linkable.

Proof Overview. We show that no such (possibly inefficient) adversary exists by assuming the linkability property of our underlying tag scheme LWE-LIT presented in Theorem 2, which holds unconditionally. Our strategy is to prove by contradiction. Assuming that an adversary winning the public-linkability experiment exists, we obtain two signatures Σ₀, Σ₁ on item such that the two tags [symbol] associated with the signatures does not link, but the two tags embed the same user secret key usk (which informally follows from the II_{Trace,b} provided by the adversary). Then, by extracting the usk from the signatures produced by the adversary, we can use ( [symbol] ,I=item,sk=usk) to win the linkability experiment of the tag scheme. Thus a contradiction.

The following two theorems follow quite naturally from the proofs of the dynamic group signatures schemes of [LNWX17]. At a high level, this is because the following security notions captures threats that should hold regardless of the presence of tags.

Theorem 6 (Traceability). Our reputation system is traceable assuming the hardness of the SIS_{n,m,q,1} problem.

Theorem 7 (Tracing Soundness). Our reputation system is unconditionally tracing sound.

### REFERENCES

ACBM08. Elli Androulaki, Seung Choi, Steven Bellovin, and Tal Malkin. Reputation systems for anonymous networks. In Privacy Enhancing Technologies, pages 202-218. Springer, 2008. 2

ACPS09. Benny Applebaum, David Cash, Chris Peikert, and Amit Sahai. Fast cryptographic primitives and circular-secure encryption based on hard learning problems. In CRYPTO, pages 595-618. Springer, 2009. 4

ALS16. Shweta Agrawal, Benoît Libert, and Damien Stehlé. Fully secure functional encryption for inner products, from standard assumptions. In Crypto, pages 333-362. Springer, 2016. 4, 15

AT99. Giuseppe Ateniese and Gene Tsudik. Some open issues and new directions in group signatures. In International Conference on Financial Cryptography, pages 196-211. Springer, 1999. 2

BBS04. Dan Boneh, Xavier Boyen, and Hovav Shacham. Short group signatures. In Crypto, volume 3152, pages 41-55. Springer, 2004. 2

BCC⁺16. Jonathan Bootle, Andrea Cerulli, Pyrros Chaidos, Essam Ghadafi, and Jens Groth. Foundations of fully dynamic group signatures. In ACNS, pages 117-136. Springer, 2016. 2, 3, 7, 10

BJK15. Johannes Blömer, Jakob Juhnke, and Christina Kolb. Anonymous and publicly linkable reputation systems. In Financial Cryptography, pages 478-488. Springer, 2015. 2, 3, 9

BLP⁺13. Zvika Brakerski, Adeline Langlois, Chris Peikert, Oded Regev, and Damien Stehlé. Classical hardness of learning with errors. In STOC, pages 575-584, 2013. 4, 15

BMW03. Mihir Bellare, Daniele Micciaucio, and Bogdan Warinschi. Foundations of group signatures: Formal definitions, simplified requirements, and a construction based on general assumptions. In EUROCRYPT, pages 614-629. Springer, 2003. 2, 7

BSO4. Dan Boneh and Hovav Shacham. Group signatures with verifier-local revocation. In Proceedings of the 11th ACM conference on Computer and communications security, pages 168-177. ACM, 2004. 2

BSS10. John Bethencourt, Elaine Shi, and Dawn Song. Signatures of reputation. pages 400-407. Springer, 2010. 2

BSZ05. Mihir Bellare, Haixia Shi, and Chong Zhang. Foundations of group signatures: The case of dynamic groups. In CT-RSA, pages 136-153. Springer, 2005. 2, 7, 9, 10

BW06. Xavier Boyen and Brent Waters. Compact group signatures without random oracles. In Eurocrypt, volume 4004, pages 427-444. Springer, 2006. 2

C⁺97. Jan Camenisch et al. Efficient and generalized group signatures. In Eurocrypt, volume 97, pages 465-479. Springer, 1997. 2

CG04. Jan Camenisch and Jens Groth. Group signatures: Better efficiency and new theoretical aspects. In SCN, volume 3352, pages 120-133. Springer, 2004. 2

CSK13. Sebastian Clauß, Stefan Schiffner, and Florian Kerschbaum. k-anonymous reputation. In ACM SIGSAC, pages 359-368. ACM, 2013. 2

CVH91. David Chaum and Eugène Van Heyst. Group signatures. In EUROCRYPT, pages 257-265. Springer, 1991. 2

Del00. Chrysanthos Dellarocas. Immunizing online reputation reporting systems against unfair ratings and discriminatory behavior. In ACM conference on Electronic commerce, pages 150-157. ACM, 2000. 2

DMS03. Roger Dingledine, Nick Mathewson, and Paul Syverson. Reputation in p2p anonymity systems. In Workshop on economics of peer-to-peer systems, volume 92, 2003. 2

EE17. Rachid El Bansarkhani and Ali El Kaafarani. Direct anonymous attestation from lattices. IACR Cryptology ePrint Archive, 2017. 4

FS86. Amos Fiat and Adi Shamir. How to prove yourself: Practical solutions to identification and signature problems. In CRYPTO, pages 186-194. Springer, 1986. 33

GK11. Michael T Goodrich and Florian Kerschbaum. Privacy-enhanced reputation-feedback methods to reduce feedback extortion in online auctions. In ACM conference on Data and application security and privacy, pages 273-282. ACM, 2011. 2

GPV08. Craig Gentry, Chris Peikert, and Vinod Vaikuntanathan. Trapdoors for hard lattices and new cryptographic constructions. In STOC, pages 197-206. ACM, 2008. 4

JI02. Audun Josang and Roslan Ismail. The beta reputation system. In Proceedings of the 15th bled electronic commerce conference, volume 5, pages 2502-2511, 2002. 2

Ker09. Florian Kerschbaum. A verifiable, centralized, coercion-free reputation system. In ACM workshop on Privacy in the electronic society, pages 61-70. ACM, 2009. 2

KSGM03. Sepandar D Kamvar, Mario T Schlosser, and Hector Garcia-Molina. The eigentrust algorithm for reputation management in p2p networks. In Proceedings of the 12th international conference on World Wide Web, pages 640-651. ACM, 2003. 2

KTX07. Akinori Kawachi, Keisuke Tanaka, and Keita Xagawa. Multi-bit cryptosystems based on lattice problems. In PKC, pages 315-329. Springer, 2007. 12, 20

KTX08. Akinori Kawachi, Keisuke Tanaka, and Keita Xagawa. Concurrently secure identification schemes based on the worst-case hardness of lattice problems. In ASIACRYPT, volume 5350, pages 372-389. Springer, 2008. 13, 26, 33

LLNW14. Adeline Langlois, San Ling, Khoa Nguyen, and Huaxiong Wang. Lattice-based group signature scheme with verifier-local revocation. In PKC, pages 345-361. Springer, 2014. 26

LLNW16. Benoît Libert, San Ling, Khoa Nguyen, and Huaxiong Wang. Zero-knowledge arguments for lattice-based accumulators: logarithmic-size ring signatures and group signatures without trapdoors. In EUROCRYPT, pages 1-31. Springer, 2016. 30

LNSW13. San Ling, Khoa Nguyen, Damien Stehlé, and Huaxiong Wang. Improved zero-knowledge proofs of knowledge for the isis problem, and applications. In PKC, volume 7778, pages 107-124. Springer, 2013. 33

LNWX17. San Ling, Khoa Nguyen, Huaxiong Wang, and Yanhong Xu. Lattice-based group signatures: Achieving full dynamicity with ease. In ACNS, pages 293-312. Springer, 2017. 2, 7, 10, 14, 15, 26, 27, 28, 29, 30, 31, 33

MK14. Antonis Michalas and Nikos Komninos. The lord of the sense: A privacy preserving reputation system for participatory sensing applications. In IEEE Symposium on Computers and Communication (ISCC), pages 1-6. IEEE, 2014. 2

MP13. Daniele Micciancio and Chris Peikert. Hardness of sis and Iwe with small parameters. In CRYPTO, pages 21-39. Springer, 2013. 4

NY90. M. Naor and M. Yung. Public-key cryptosystems provably secure against chosen ciphertext attacks. In STOC, pages 427-437. ACM, 1990. 7, 30

Pei09. Chris Peikert. Public-key cryptosystems from the worst-case shortest vector problem. In STOC, pages 333-342. ACM, 2009. 4

Pei10. Chris Peikert. An efficient and parallel gaussian sampler for lattices. CRYPTO, pages 80-97. Springer, 2010. 19

PVW08. Chris Peikert, Vinod Vaikuntanathan, and Brent Waters. A framework for efficient and composable oblivious transfer. In CRYPTO, pages 554-571. Springer, 2008. 12, 30

Reg05. Oded Regev. On lattices, learning with errors, random linear codes, and cryptography. In STOC, pages 84-93. ACM Press, 2005. 4, 7, 19, 30

RKZF00. Paul Resnick, Ko Kuwabara, Richard Zeckhauser, and Eric Friedman. Reputation systems. Communications of the ACM, 43(12):45-48, 2000. 1

RZ02. Paul Resnick and Richard Zeckhauser. Trust among strangers in internet transactions: Empirical analysis of ebay's reputation system. In The Economics of the Internet and E-commerce, pages 127-157. Emerald Group Publishing Limited, 2002. 2

SKCD16. Kyle Soska, Albert Kwon, Nicolas Christin, and Srinivas Devadas. Beaver: A decentralized anonymous marketplace with secure reputation. Cryptology ePrint Archive, Report 2016/464, 2016. 2

Ste96. Jacques Stern. A new paradigm for public key identification. IEEE Transactions on Information Theory, 42(6):1757-1768, 1996. 33

Ste06. Sandra Steinbrecher. Design options for privacy-respecting reputation systems within centralised internet communities. Security and Privacy in Dynamic Environments, pages 123-134, 2006. 2

ZWC⁺16. Ennan Zhai, David Isaac Wolinsky, Ruichuan Chen, Ewa Syta, Chao Teng, and Bryan Ford. Anonrep: Towards tracking-resistant anonymous reputation. In NSDI, pages 583-596, 2016. 2

### A Proof of Theorem 1

Proof. Provided with an adversary 6z,91 for the tag-indistinguishability experiment with advantage ∈ that makes at most Q random oracle queries, we construct an algorithm [symbol] for the LW [symbol] problem having advantage ∈−negl. In particular, [symbol] is given ((Aᵢ, bᵢ)∈ [symbol] _{q}^{m×w}× [symbol] _{q}^{w})_{i∈[Q]}as the LWE challenge, where bᵢ=Aᵢ^{T}s+eᵢ for some s∈ [symbol] and eᵢ∈ [symbol] or bᵢ← [symbol] _{q}^{w}. First, [symbol] samples vectors s← [symbol] ēᵢ← [symbol] for i∈[Q] and prepares vectors of the form (bᵢ⁽⁰⁾,bᵢ⁽¹⁾)=(bᵢ+Aᵢ^{T}s̅+ēᵢ,bᵢ−Aᵢ^{T}s̅−eᵢ). Then, using standard discrete Gaussian techniques (See. [Reg05, Pei10]), in case bᵢ is of the form Aᵢ^{T}s+eᵢ, we can prove that the distributions of (bᵢ⁽⁰⁾,bᵢ⁽¹⁾) are statistically close to (Aᵢ^{T}s⁽⁰⁾+eᵢ⁽⁰⁾, Aᵢ^{T}s⁽¹⁾+eᵢ⁽¹⁾) where s^{(j)}← [symbol] _{,β′}and eᵢ^{(j)}← [symbol] _{,β′}for all j∈{0,1},i∈[Q]. We emphasize that all secret vectors s^{(j)} and error vectors eᵢ^{(j)} are distributed independently.⁷ Here, due to our parameter selection, with all but negligible probability we would have s⁽⁰⁾,s⁽¹⁾∈ [symbol] . Below, we describe how [symbol] simulates the tag-indistinguishability experiment for [symbol] . Without loss of generality, we assume for simplicity that the messages queried to the tag oracle and the challenge message I* outputted by [symbol] are always queried to the random oracle [symbol] (·) beforehand. ⁷ If these vectors were distributed according to the continuous Gaussian distributions, this would trivially follow from the convolution property of the continuous Gaussian distributions. However, in the case for discrete Gaussian distribution, we have to take care of some subtleties, since in general the convolution property does not hold.

At the beginning of the experiment [symbol] initializes the two sets V₀,V₁←∅ and also a counter c:=1. When [symbol] submits a random oracle query on I∈ [symbol] , it checks wether I has already been queried. If so, it outputs the previously returned matrix. Otherwise, it returns A_{c}∈ [symbol] [symbol] and programs the random oracle so that [symbol] (i)=A_{c}. Finally, it increments c:=c+1. When A queries the tag oracle on (j,I), [symbol] proceeds with the two If statements depicted in FIG. 1 as done by the real tag oracle. For the Else statement, [symbol] retrieves A_{c}= [symbol] (I) for some c∈[Q] and sets the corresponding LWE vector b_{c}^{(j)} as the tag [symbol] . Finally it appends (I, [symbol] ) to Vⱼ and returns [symbol] . For the challenge tag, [symbol] first retrieves A_{c*}= [symbol] (I*) for some c*∈[Q]. Then, if [symbol] is simulating the) tag-indistinguishability experiment for b∈{0, 1}, it returns b_{c*}^{(b)} as the challenge tag [symbol] * to [symbol] . The rest is the same.

In case [symbol] is given valid LWE samples, [symbol] perfectly simulates the two tag-indistinguishability experiment for [symbol] with all but negligible probability. Therefore, the advantage of [symbol] for this simulated experiment would be ∈−negl. On the other hand, when [symbol] is given random LWE samples, the challenge tag [symbol] *−b_{c*}^{(b)} is distributed uniformly random from all the tags [symbol] has received via the tag oracle, since [symbol] will not obtain b_{c*}^{1-b} by definition of the experiment. Therefore, the advantage of [symbol] for this simulated experiment would be exactly 0. Thus, [symbol] will be able to distinguish between valid LWE samples and random LWE samples with probability ∈−negl. This concludes the proof.

### B Security Experiments

We present the rest of the security experiments in FIG. 5 , but first we will define the lists/tables and oracles that are used in the security experiments. The lists/tables are defined as follows where all of them are initialized to be the empty set: table HUL for honest users and their assigned user identifier associated with some item, list BUL for users whose secret signing keys are known to the adversary, table CUL for users whose public keys are chosen by the adversary and their assigned user identifier associated with some item, list SL for all signatures that are generated by the Sign Oracle, and finally list CL for signatures that are generated by the oracle Chal_{b}. Since every user possess a unique public key upk, whenever it is clear from context, we describe users by their associating upk. The oracles are defined as follows:

RUser(item,uidᵢₜₑₘ) : It returns ⊥, if reg[item][uidᵢₜₑₘ] is not defined. Otherwise, it returns the unique user upk stored in reg[item][uidᵢₜₑₘ].

AddU ): This oracle does not take any inputs, and when invoked, it adds an honest user to the reputation system at the current epoch. It runs (upk, usk)←UKgen(1ⁿ) and returns the user public key upk to the adversary. Finally, it initializes an empty list HUL[upk] at index upk.

CrptU(upk): It returns ⊥, if HUL[upk] is already defined. Otherwise, it creates a new corrupt user with user public key upk and initializes an empty list CUL[upk] at index upk.

SndToGM(item,upk,·): It returns ⊥, if CUL[upk] is not defined or has been already queried upon the same (item,upk). Otherwise, it engages in the (Join ↔Issue) protocol between a user upk (corrupted by the adversary) and the honest group manager. Finally, it adds the newly created user identifier uidᵢₜₑₘ associated with item to list CUL[upk].

SndToU(item,upk,·): It returns ⊥, if HUL[upk] is not defined or has been already queried upon the same (upk,item). Otherwise, it engages in the (Join ↔Issue) protocol between the honest user upk and the group manager (corrupted by the adversary). Finally, it adds the newly created user identifier uidᵢₜₑₘ associated with item to list HUL[upk].

RevealU (item,upk): It returns ⊥ if HUL[upk] is not defined or empty. Otherwise, it returns the secret signing key gsk[itern][uidᵢₜₑₘ] for all uidᵢₜₑₘ∈HUL[upk] to the adversary, and adds upk to BUL.

Sign(uidᵢₜₑₘ,infoₜ,item,M): It first runs X←RUser(item,uidᵢₜₑₘ) and returns ⊥ in case X=⊥. Otherwise, set upk=X. Then, it checks if there exists a tuple of the form (upk,uidᵢₜₑₘ,-,item,-,-)∈SL, where − denotes an arbitrary string. If so it returns ⊥. Otherwise it returns a signature ∈ on message M for item signed by the user upk assigned with the identifier uidᵢₜₑₘ at epoch t. It then adds (upk,uidᵢₜₑₘt,item,M,∈) to the list SL.

Chal_{b}(infoₜ,uid₀,uid₁,item,M)⁸: It first checks that RUser(item,uid₀), RUser(item,uid₁) are not ⊥, and that users uid₀ and uid₁ are active at epoch t. If not it returns ⊥. Otherwise, it returns a signature ∈ on M by the user uid_{b} for item at epoch t, and adds (uid₀,uid₁,item,M,∈) to the list CL. ⁸ Here, we omit the item from the subscript of uid for better readability.

Trace(infoₜ,item,M,∈): If Σ∉CL, it returns the user identifier uidᵢₜₑₘ, of the user who produced the signature together with a proof, with respect to the epoch t.

RepUpdate(R): It updates the groups at current epoch t_{current}, where R is a set of active users at the current epoch to be revoked.

RReg(item,uidᵢₜₑₘ): It returns reg[item][uidᵢₜₑₘ]. Recall, the unique identity of the user upk is stored at this index.

MReg(item,uidᵢₜₑₘ,ρ): It modifies reg[item][uidᵢₜₑₘ] to any ρ chosen by the adversary.

### C Security Proofs

### C.1 Anonymity

Theorem 8 (Anonymity). Our reputation system is anonymous, assuming the hardness of the decision LWE_{n,q,χ}problem.

Proof. We show that [symbol] (n)− [symbol] (n)|≤negl through a series of indistinguishable intermediate experiments. In the following let Eᵢ be the event that the adversary [symbol] outputs 1 in the i-th experiment Expᵢ. Further, let T_{i,1} and T_{i,2} denote the event that the adversary queries the Trace oracle on a valid signature (II_{Sign,} [symbol] _{,c}_{₁}_{,c}_{₂}), where c₁ and c₂ are ciphertexts of different plaintexts, in Expᵢ. Note that since Pr[T_{i,1}]+Pr[T_{i,2}]=1, we have Pr[Eᵢ]=Pr[Eᵢ∧T_{i,1}]+Pr[Eᵢ∧T_{i,2}].

Exp₀ : This is the real experiment [symbol] (n). By definition, we have Pr[E₁]=Pr[ [symbol] (n)=1].

Exp₁: This experiment is the same as Exp₁ except that we add (S₂, E₂) to the tracing secret key tsk. Since this does not change the view of the adversary, we have Pr[E₁]=Pr[E₂].

Exp₂: In this experiment, we change the way the Trace oracle answers to [symbol] . Instead of creating an actual zero-knowledge proof II_{Trace}, it simulates a zero-knowledge proof by programming the random oracle [symbol] _{Trace}. Due to the zero-knowledge property, this changes the view of the adversary negligibly. In particular, we have

|Pr[E₁]−Pr[E₂]|≤Adv_{II}_{_{Trace}}^{zero-knowledge=negl.}

Exp₃: In this experiment, we further change the way the Trace oracle answers to [symbol] . Namely, when submitted a signature (II_{sign}, [symbol] ,c₁,c₂), the Trace oracle uses S₂ to decrypt c₂, instead of using S₁ to decrypt c₁. Therefore, the view of the adversary [symbol] is unchanged unless c₁ and c₂ are ciphertexts of different plaintexts. In particular,

$$\vert Pr [ {E}_{2} ] - Pr [ {E}_{3} ] \vert = \vert ( Pr [ {E}_{2} ⋀ {T}_{2 , 1} ] + Pr [ {E}_{2} ⋀ {T}_{2 , 2} ] ) - ( Pr [ {E}_{3} ⋀ {T}_{3 , 1} ] + Pr [ {E}_{3} ⋀ {T}_{3 , 2} ] ) \vert = \vert Pr [ {E}_{2} ⋀ {T}_{2 , 2} ] - Pr [ {E}_{3} ⋀ {T}_{3 , 2} ] \vert \leq max \{ Pr [ {T}_{2 , 2} ] , Pr [ {T}_{3 , 2} ] \} .$$

Now, due to the soundness of our NIZKAoK for the relation II_{Sign}, Pr[T_{2,2}] and Pr[T_{3,2}]are negligible. Hence, |Pr[E₂]−Pr[E₃]|≤Adv_{II}_{_{Sign}}^{zk-soundness}=negl.

Exp₄: In this experiment, we change the way the Chal₀ oracle responds to the challenge query. Instead of creating an actual zero-knowledge proof II_{Sign}, it simulates a zero-knowledge proof by programming the random oracle [symbol] _{Sign}. Due to the zero-knowledge property, this changes the view of the adversary negligibly. In particular, we have

|Pr[E₃]−Pr[E₄]|≤Adv_{II}_{_{Sign}}^{zero-knowledge}=negl.

Exp₅: In this experiment, we change the response to the challenge query so that it uses a tag [symbol] instead of tag [symbol] . Then, we have the following, assuming tag indistinguishability of the underlying tag scheme:

|Pr[E₄]−Pr[E₅]|≤Adv_{LIT}^{Tag-Ind}=negl.

In particular, we construct an adversary [symbol] for the tag-indistinguishability experiment, which simulates the view of [symbol] . In particular, when [symbol] queries the signing oracle for uid_{item,j} on item, it invokes its tag oracle [symbol] _{Tag}(j,item) and uses the returned tag to generate a valid signature for [symbol] . When [symbol] queries the challenge oracle on item*, [symbol] submits item* as its own challenge message and receives [symbol] *, which is either a valid tag for uid₀ or uid₁, and simulates the challenge signature as in Exp₄ using [symbol] *. Since, [symbol] queries the signing oracle at most n times, [symbol] can successfully simulate the experiment to [symbol] . It is then clear that we have the above inequality. Note that this reduction works as long as [symbol] invokes the random oracle [symbol] _{Tag} a polynomial number of times, which is exactly the case we have. Due to Theorem 1, tag indistinguishability of the underlying tag scheme LWE-LIT holds assuming decision LWE_{m,q,χ}.

Exp₆: In this experiment, we further change the response to the challenge query so that c₁ now encrypts uid_{item,1}. By the semantic security of the encryption scheme for public key (B, P₁), this change is negligible to the adversary. Note that the Trace oracle uses secret key S₂ and does not require S₁ in this experiment. Therefore, we have

|Pr[E₅]−Pr[E₆]|≤Adv_{Encrypt}^{sem-security}=negl.

Exp₇: This experiment is the same as the previous experiment except that the Trace oracle switches back to using secret key S₁ and discards S₂ as in the original experiment. Following the same argument made at Exp₃, the view of the adversary [symbol] is unchanged unless [symbol] queries the Trace oracle on a valid signature such that c₁ and c₂ are cipliertexts of different plaintexts. Using the same argument as before, we obtain the following:

|Pr[E₆]−Pr[E₇]|≤Adv_{II}_{_{sign}}^{zk-soundness}=negl.

Exp₈: In this experiment, we change the response to the challenge query so that c₂ encrypts uid₁. Observe that due to the change we made in Exp₅ and Exp₆, (c₁,c₂, [symbol] ₁) are now associated of uidᵢₜₑₘ. In particular, this is the same as the Chal₁ oracle. Now as done in Exp₆, by the semantic security of the encryption scheme for public key (B, P₂), this change is negligible to the adversary. Therefore, we have

|Pr[E₇]−Pr[E₈]|≤Adv_{Encrypt}^{sem-security}=negl.

Exp₉: In this experiment, we change back the Chal₁ oracle to generate a real zero-knowledge proof for II_{Sign} instead of generating a simulated proof. Due to the zero-knowledge property, this changes the view of the adversary negligibly. In particular, we have

|Pr[E₈]−Pr[E₉]|≤Adv_{II}_{_{Sign}}^{zero-knowledge}=negl.

Exp₁₀: This is the final experiment, where the Trace oracle answers to [symbol] by a real zero-knowledge proof II_{Trace} instead of a simulated zero-knowledge proof. Due to the zero-knowledge property, this changes the view of the adversary negligibly. In particular, we have

|Pr[E₉]−Pr[E₁₀]|≤Adv_{II}_{_{Trace}}^{zero-knowledge}=negl.

Here, observe that Exp₁₀ is identical to the real experiment 6 [symbol] (n). Namely, we have Pr[E₁₀]=Pr[ [symbol] (n)=1].

Combining everything together, we have the following as desired:

| [symbol] (n)− [symbol] (n)|≤negl.

### C.2 Non-Frameability

Theorem 9 (Non-Frameability). Our Reputation. System is non-frameable, assuming the hardness of the SIS_{n,m,q,1} problem of the search faeLWE_{m,n,q,χ}(or equivalently the search LWE_{m-n,q,χ}) problem.

Proof. Assume there exists an adversary [symbol] that has a non-negligible advantage ∈ in the non-frameability experiment. For [symbol] to win the experiment, he must output a tuple (uid*_{item*},II*_{Trace},info_{t*},item*,M*,Σ*) such that (informally): (i) the pair (M*,Σ*) links to some other message-signature pair (M,Σ) corresponding to item* of an honest non-corrupt user or (ii) the proof II*_{Trace} traces the signature Σ* back to some honest non-corrupt user. We denote the event that case (i) (resp. (ii)) happens by E₁ (resp. E₂). By definition, we must have that either Pr[E₁] or Pr[E₂] is non-negligible. Below, we show that by using [symbol] , we can construct an adversary [symbol] that can either solve the search faeLWE_{m,n,q,χ}problem (in case event E₁ occurs) or the SIS_{n,m,q,β}problem (in case event E₂ occurs) with non-negligible probability. At a high level, for either cases, [symbol] runs the forking algorithm on [symbol] to extract the witness from the signature Σ*, which he would use to win either the faeLWE or SIS problem. In the following, we assume without loss of generality that [symbol] guesses correctly which event E₁ or E₂ occurs on the first run of [symbol] ; we run [symbol] three times to apply the forking lemma.

In case of event Eₗ: Assume [symbol] is provided (Ā, v̅)∈ [symbol] _{q}^{m×n}× [symbol] _{q}ⁿ and ((Bᵢ, vᵢ)∈ [symbol] _{q}^{m×w}× [symbol] _{q}^{w})_{i∈[Q]}as the search faeLWE_{m,n,q,χ}problem, where Q denotes the number of random oracle queries [symbol] makes to [symbol] _{Tag}. Here, we assume (Ā, v are the LWE samples that are noise-free and the other ((Bᵢ, vᵢ))_{i∈[Q]}are standard LWE samples, i.e., A^{T}s=v and Bᵢ^{T}s+eᵢ=vᵢ for some s←D [symbol] _{^{m}}_{,χ}and eᵢ←D [symbol] _{^{w}}_{,χ}. Now, [symbol] simulates the non-frameability experiment for [symbol] by first generating the public parameters pp as in the real experiment, with the only exception that he uses the matrix Ā provided by the faeLWE problem instead of sampling a random matrix. Namely, [symbol] sets A:=Ā^{T}∈ [symbol] _{q}^{n×m}. As for the random oracle queries, when [symbol] is queried on [symbol] _{Tag} on the k-th (k∈[Q]) unique item, it programs the random oracle as [symbol] _{Tag}(item)=Bᵢ and returns Bᵢ. Here, [symbol] returns the previously programmed value in case it is queried on the same item. For the other random oracles [symbol] _{Sign}, [symbol] _{Trace}, [symbol] answers them as done in the real experiment. Furthermore, [symbol] samples a critical user t*←[N], where N denotes the number of honest users generated by [symbol] via the AddU oracle, which we can assume to be polynomial. In other words, N denotes the number of upk such that a list HUL[upk] is created. Recall that [symbol] may further invoke the oracles SndToU and RevealU for the users that he had added via the AddU oracle. Finally, [symbol] provides pp to [symbol] and starts the experiment. During the experiment, in case [symbol] queries the RevealU on user t*, [symbol] aborts the experiment. Since [symbol] is a valid adversary, there must be at least one upk such that HUL[upk] is non-empty and upk∉BUL. Therefore, the probability of [symbol] not aborting is at least 1/N. In the simulation, [symbol] deals with all the noncritical users [N]\{t*} as in the real experiment, i.e., [symbol] properly generates a new pair of (upk,usk)←UKgen(1ⁿ) when queried the oracle AddU and uses upk, usk to answer the rest of the oracles. Below, we provide details on how [symbol] deals with the critical user t*.

At a high level, [symbol] aims to simulate the experiment so that the secret key usk_{t*} associate to the user t* will be the solution to the search faeLWE problem, i.e., upk_{t*}=v̅∈ [symbol] _{q}ⁿ, usk_{t*}=s∈ [symbol] _{q}^{m}. There are two oracle queries on which [symbol] must deviate from the real experiment: AddU and Sign. In case [symbol] runs the AddU to add the t*-th unique user to the reputation system, [symbol] sets the user public key as upk_{t*}=bin(v̅v)∈{0, 1}^{nk}. By this, [symbol] implicitly sets the user secret key usk_{t*}=s. Now, to answer Sign queries for user upk_{t*}⁹ on item, it first retrieves Bᵢ= [symbol] _{Tag}(item) for some i∈[Q] and the corresponding LWE sample vᵢ, which is essentially a valid tag [symbol] . Finally, 6z,147 runs the ZKAoK simulator for the relation [symbol] _{Sign} and returns the signature Σ=(II_{Sign,} [symbol] _{,c}_{₁}_{c}_{₂}) to [symbol] . It also adds (uid_{item,t*},m,item,t,Σ) to the list SL, where uid_{item,t*} is the user identifier issued to user t* for item. Note that for [symbol] to have queried a signature by user upk_{t*} for item, it must have queried SndToU(item,upk_{t*}), at which the user identifier uid_{item,t*} is defined. Now, assuming the hardness of the underlying encryption scheme (whose security is based on a strictly weaker LWE problem than our assumption), the experiment thus far is computationally indistinguishable from the real experiment. Therefore, at some point [symbol] outputs with probability ∈·Pr[E₁] a tuple (uid*_{item*},II*_{Trace},info_{t*},item*,M*,Σ*) such that the signature Σ* is valid, ┌(upk,uid_{item*},t,item*,M,Σ)∈SL such that uid_{item*}∈HUL[upk]≜upk∉BUL, and Link(gpk,item*,(M*, Σ*), (M,Σ))=1. Since [symbol] simulates upk_{t*} and the other ⁹ Note that we now specify the critical user by its defined user public key. user public keys perfectly, the probability that upk_{t*}=upk is at least 1/N. Now, if we let [symbol] , [symbol] * be the two tags associated with the signatures Σ,Σ*, respectively, we have

Link(gpk,item*,(M*,Σ*),(M,Σ))=1⇔Link_{LIT}( [symbol] *, [symbol] )=1

Now, we use the forking algorithm on [symbol] to extract a witness which includes the secret key usk*=x* used to create the tag [symbol] *. For a more formal and thorough discussion refer [LNWX17], Lemma 3. Here, observe that since we are using a statistically binding commitment scheme of [KTX08], x* is the actual must be the actual secret key used to construct the signature (i.e., zero-knowledge proof). Therefore, assuming that [symbol] = [symbol] _{Tag}(item)^{T}s+eᵢ=BᵢTs+eᵢ for some i∈[Q], we can rewrite Eq. (1) as

∥Bᵢ^{T}(x*−s)+e*−eᵢ∥∞≤2β,

where e* is the noise vector used to create [symbol] *. Furthermore, since the noise vectors where sampled from a β-bounded distribution, we have

∥Bᵢ^{T}(x*−s)∥∞≤4β.

Finally, we prepare the following lemma presented in [LLNW14].

Lemma 1 ([LLNW14], Lemma 4). Let β=poly(n), q≥(4β+1)² and w≥3m. Then, over the randomness of B← [symbol] _{q}^{m×w}, we have

Pr[┌non-zero s∈ [symbol] _{q}^{m}:∥B^{T}s∥∞≤4β]=negl(n).

Then, due to our parameter selections, we have s=x* with overwhelming probability. Hence, we can solve search faeLWE with non-negligible probability. In case of event E₂: In this case, we can use the same argument made in the non-frameability proof of the group signature scheme of [LNWX17], i.e., we can construct an algorithm [symbol] that solves the SIS_{n,m,q,1} problem with non-negligible probability. The reason why the same proof works for our reputation system, which is essentially a group of group signature, is because all users are assigned a unique user public key upk and all the user identifiers {uidᵢₜₑₘ}ᵢₜₑₘ are uniquely bound to upk. In addition, it can easily be checked that the presence of the tags do not alter the proof in anyway. For the full detail, refer to [LNWX17], Lemma 3.

### C.3 Public Linkability

Theorem 10 (Public Linkability). Our reputation system is unconditionally public-linkable.

Proof. We show that no such (possibly inefficient) adversary exists by assuming the linkability property of our underlying tag scheme LWE-LIT presented in Theorem 2, which holds unconditionally. Let us prove by contradiction and assume an adversary [symbol] that wins the public-linkability experiment with non-negligible advantage. In particular, [symbol] will at some point during the experiment output a tuple of the form (item,uidᵢₜₑₘ,infoₜ,{(M_{b},Σ_{b},II_{Trace,b})}_{b=0,1}). By the winning condition, the two tags [symbol] associated with the signatures does not link. At a high level, the simulator needs to extract the secret keys usk₀, usk₁ embedded in the tags [symbol] and check whether if usk₀=usk₁ actually holds as the adversary claims with the tracing proofs II_{Trace}_{₀},II_{Trace}_{₁}. If the two extracted secret keys are indeed equivalent, i.e., usk₀=usk₁, then the simulator can use ( [symbol] ,I=item,sk=usk₀) to win the linkability experiment of the tag scheme, which is a contradiction. Therefore, the proof boils down to whether we can extract the witnesses from the two signatures Σ₀, Σ₁, which should be in contrast to the usual setting where the simulator is only required to extract a witness from a single signature Σ, e.g., proof of non-frameability. In fact, we can extract both witnesses by in a sense running the forking lemma. twice. By standard arguments, there must be two critical random oracle queries that are used as the challenge for the NIZK proof to create the signatures Σ₀,Σ₁. Assume without a loss of generality that the critical random oracle query concerning Σ₀occurred before that of Σ₁. Then the simulator first runs the forking lemma on [symbol] , where the fork is set to the point where [symbol] submits the second critical random oracle query. Then, by the forking lemma, the simulator would be able to extract the witness, which includes usk₁, used to create Σ₁. Then, keeping the same random tape for [symbol] , the simulator further runs the forking lemma on [symbol] , where the fork is now set to the point where [symbol] submits the first critical random oracle query. By the same argument, the simulator will obtain usk₀.

The following two theorems follow quite trivially from the proofs of the dynamic group signatures schemes of [LNWX17]. This is mainly because traceability and tracing soundness are somewhat security notions irrelevant to tags, and the proofs work similarly regardless of the presence of the tag inside the signature.

### C.4 Traceability

Theorem 11 (Traceability). Our reputation system is traceable assuming the hardness of the SIS_{n,m,q,1} problem.

Proof. The adversary wins the traceability game in two cases; the first when he manages to output a signature that traces back to an inactive user; this only happen with negligible probability based on the security of the accumulator being used. The second winning case, is when the adversary outputs a signature that traces to an active user, but the tracer can't generate a proof of correct opening that will be accepted by the Judge; this clearly reduces to the completeness property of II_{Trace}.

### C.5 Tracing Soundness

Theorem 12 (Tracing Soundness). Our reputation system is unconditionally tracing sound.

Proof. Briefly, if the adversary manages to output a signature that traces to two different users, with two valid proofs of correct opening, then starting from this hypothesis, one can easily reach a contradiction by finding two different solutions to an LWE sample, that supposedly has, at most, one solution.

### D Building Blocks

### D.1 Accumulators

An accumulator scheme consists of the following PPT algorithms:

TSetup(n): On input the security parameter n, it returns the public parameter pp.

TAccₚₚ(R): On input the public parameter and a set R={d₀, . . . , d_{N-1}}, it accumulates the data points into a value u. It then outputs u.

TWitnessₚₚ(R, d): On input the public parameter, the set R and a data point d, this algorithm outputs ⊥ if d∉R, and outputs a witness w for the statement that d is accumulated into u otherwise.

TVerifyₚₚ(d, w, u): On input, the public parameter, the value d, the witness and the accumulated value u, it outputs 1 if w is a valid witness. Otherwise it outputs 0.

Correctness. An accumulator scheme Accum is correct if, for all pp←TSetup(n), we have

TVerifyₚₚ(d,TWitnessₚₚ(R, d), TAccₚₚ(R))=1,

for all d∈R.

Security of an accumulator Consider the experiment presented in FIG. 6,

Definition 3. An accumulator scheme Accum is secure if for all PPT [symbol] we have

Pr[ [symbol] (n)=1]≤negl(n).

### D.2 A Lattice-Based Hash Function

Lemma 2 ([LNWX17]).

Given A=[A₀|A₁]∈ [symbol] , _{q}^{n×m} with A₀,A₁∈ [symbol] _{q}^{n×nk}. Define the function h_{A} as follows; h_{A}: {0,1}^{nk}×{0,1}^{nk}→{0,1}^{nk} where

h_{A}( [symbol] )=bin(A₀· [symbol] +A₁· [symbol] mod q)∈{0,1}^{nk}.

If SIS_{n,m,q,1} is hard, then [symbol] ={h_{A}:A∈ [symbol] _{q}^{n×m}} is a family of collision-resistant hash functions.

Remark 1. One can easily verify that, h_{A}(u₀,u₁)=u if and only if A₀·u₀+A₁·u₁=G·u mod q. where,

$$G = [ \begin{matrix}124 {…2}^{k - 1} & & \\ & … & \\ & & 124 {…2}^{k - 1}\end{matrix} ] ∈ {ℤ}_{q}^{n \times nk} ,$$

### D.3 An Accumulator Scheme from Lattices

Using this previously defined family of lattice based hash functions, we now recall the accumulator scheme presented in [LNWX17]. It consists of the following PPT algorithms:

TSetup(n): Output pp=A← [symbol] _{q}^{n×m}.

TAcc_{A}(R): Given R={d₀∈{0,1}^{nk}, . . . ,d_{N-1}∈{0,1}^{nk}}. These values will be fed to the tree at the leaves level. For each j∈[0, . . . ,N−1], let bin(j)=(j₁, . . . ,j_{ι})∈{0,1} [symbol] be the binary representation of j, and let dⱼ=u_{j1, . . . ,jι}. Let [symbol] =log N be the depth of the tree, it constructs the tree as follows;
(a) At tree depth i∈[ [symbol] ], we define the node value u_{b}_{₁}, . . . ,bᵢ as follows;

u_{b}_{₁}, . . . ,bᵢ=h_{A}(u_{b}_{₁}, . . . ,bᵢ,0,u_{b}_{₁}, . . . ,bᵢ,1) (2)
(b) At the top of the tree, we have the root u defined as h_{A}(u₀,u₁). It finally outputs u.

TWitness_{A}(R, d): It outputs ⊥ if d∉R. Otherwise, there exists a j∈[0,N−1] with binary representation given by (j₁. . . ,j_{ι}), s.t. d=dⱼ, it computes the witness w as follows;

w=((j₁, . . . , [symbol] ), ( [symbol] , . . . , [symbol] ))∈{0,1 [symbol] ×({0,1 [symbol] (3)

for ( [symbol] _{, . . . ,} [symbol] ) calculated by algorithm TAcc_{A}(R).

TVerify_{A}(d, w, u): Given a witness w, where

w=((j₁, . . . , [symbol] ),( [symbol] . . . ,w₁))∈{0,1 [symbol] ×({0,1 [symbol] , (4)

the algorithm sets [symbol] =d and recursively computes vᵢ for i ∈{ [symbol] −1, . . . , 0}, as follows;

$${v}_{i} = \{ \begin{matrix}{h}_{A} ( {v}_{i + 1} , {w}_{i + 1} ) , for {j}_{i + 1} = 0 , \\ {h}_{A} ( {w}_{i + 1} , {v}_{i + 1} ) , for {j}_{i + 1} = 1.\end{matrix} \qquad ( 5 )$$

If v₀=u, return 1. Otherwise, return 0.

TUpdate_{A}(bin(j),d*): Let dⱼ be the current value at the leaf of position determined by bin(j), and let ((j₁, . . . , [symbol] , ( [symbol] , . . . ,w_{j,1})) be its associated witness. It sets [symbol] :=d* and recursively computes the path [symbol] . . . ,v₁,v₀∈{0,1}^{nk} as in (5). Then, it sets u:=v₀,uⱼᵢ:=v₁; . . . ; [symbol] := [symbol] ; [symbol] := [symbol] =d*.

Theorem 13 ([LLNW16]). If the SIS_{n,m,q,1} problem is hard, then the lattice-based accumulator scheme is correct and secure.

### D.4 Underlying Regev's Encryption Scheme

We use the Naor-Yung paradigm [NY90] to prove anonymity of our reputation system. In particular, we encrypt the identity of the signer uid twice using Regev's encryption scheme and prove in zero-knowledge that the two ciphertexts encrypt the same identity. Below, we provide the multi-bit variant of the Regev's encryption scheme for encrypting the same message twice [Reg05, KTX07, PVW08].

KeyGen_{Regev}(1ⁿ): It samples B← [symbol] _{q}^{n×m}^{_{E}},Sᵢ← [symbol] ,Eᵢ← [symbol] for i ∈{1, 2}. It then computes two LWE samples as Pᵢ=Sᵢ^{T}B+E and sets pk_{Enc}:=(B,P₁, P₂) and sk_{Enc}:=(S₁,E₁).

Enc_{Regev}((B,P₁,P₂), m ∈{0,1 [symbol] ): It samples r←{0,1}^{m}^{_{E}} and computes

$$( {c}_{1} , {c}_{2} ) = ( ( B \cdot r , {P}_{1} \cdot r + ⌊ \frac{q}{2} ⌉ \cdot m ) , ( B \cdot r , {P}_{2} \cdot r + ⌊ \frac{q}{2} ⌉ \cdot m ) ) ∈ {( {ℤ}_{q}^{n} \times {ℤ}_{q}^{l} )}^{2} .$$

Dec_{Regev}((S₁,E₁),c): it parses c into (c₁,c₂,c₃) and outputs

m:=└(c₂−S₁^{T}·c₁)/(q/2)┐.

### E Zero-Knowledge Arguments for our Reputation System

We will present the the stern-like zero-knowledge argument that we use for our reputation system. We start by explaining the change that we make to the Merkle-tree used in [LNWX17] to bind it to item associated to it, then we recall the abstracted Stern-like protocols for ISIS problem. Next, we will give a sketch of the NIZKAoK for the [symbol] _{Sign} used to generate a signature/review.

### E.1 A Merkle-Tree for our Reputation System

This diagram illustrates the Merkle-tree accumulator given in Section (D.3). For instance, w={(011),u₀₁₀,u₀₀u₁} is the witness that proves that p₃ was accumulated in a Merkle-tree whose root is uᵢₜₑₘ.

### E.2 Abstracted Stern-Like Zero-Knowledge Proofs

Given the following relation,

R_{ISIS}:={((M,y)z)∈ [symbol] _{q}^{x×D}× [symbol] _{q}ⁿ{−1,0,1}^{D}:z∈VALID∧(M·z=y mod q)}, where VALID is to be defined. For instance, VALID could be the set of vectors that have an infinity norm bounded by a positive integer β if the vector z is a single vector that is a solution to an ISIS problem, but VALID could as well be a set of conditions to be satisfied by various parts of z, when z is the concatenation of several vectors that satisfy different equations, which is the case of our reputation system. Regardless of how complex the set VALID looks like, we can always use the Stern-like protocol given in FIG. 8 to prove knowledge of a witness z∈VALID and that satisfies the equation M·z=y, where M and y are public.

Theorem14 ([LNWX17]). If SIVP [symbol] ₍ₙ₎ problem is hard, then the stern-like protocol described in FIG. 8 is a statistical ZKAoK with perfect completeness, soundness error 2/3, and communication cost [symbol] (D log q). Moreover, there exists a polynomial-time knowledge extractor that, on input a commitment CMT and 3 valid responses (RSP₁, RSP₂, RSP₃) to all 3 possible values of the challenge CH, outputs x′∈VALID such that A·x′=u mod q.

### E.3 NIZKAoK for our Reputation System

Recall the relation for the NIZKAoK used in the signing algorithm;

R_{Sign}={(A,u [symbol] _{Tagg}(item), [symbol] ,c₁,c₂,B,P₁,P₂),(p,wⱼ,x,e,uid,r₁,r₂): p≠0^{nk}∧TVerify_{A(}p,wⱼ,u)=1∧A·x=G·p mod q,∧(Enc_{Regev((}B,Pᵢ),bin(j))=cᵢ,i=1,2)∧ [symbol] = [symbol] _{Tag}(item)^{T}x+e}

We will deal with the equations one by one; regarding TVerify_{A}, one can easily notice that the computations given in (5) are equivalent to the following computation; For all i∈{ [symbol] −1, . . . ,0},

vᵢ=j̅ᵢ₊₁·h_{A(}vᵢ₊₁,wᵢ₊₁)+jᵢ₊₁h_{A}(wᵢ₊₁,vᵢ₊₁). (6)

Using Remark (1), eqaution (6) is equivalent to

j̅ᵢ₊₁(A₀·vᵢ₊₁+A₁·wᵢ₊₁)+j_{i+1·}(A₀·wᵢ₊₁+A₁·vᵢ₊₁)mod q=G·vᵢ (7)

Let ext(b,v), for bit b and vector v denote the vector

$$( \begin{matrix}\overline{b} \cdot v \\ b \cdot v\end{matrix} ) ,$$

Now equation (7) can be rewritten as

A·ext(jᵢ₊₁,vᵢ₊₁)+A·ext(j̅ᵢ₊₁,wᵢ₊ᵢ)=G·vᵢ mod q. (8)

We can now state that proving that TVerify_{A} (p,wⱼ,u)=1 is equivalent to proving the satisfiability of the following equations;

$$\{ \begin{matrix}A \cdot ext ( {j}_{1} , {v}_{1} ) + A \cdot ext ( {\overline{j}}_{1} , {w}_{1} ) = G \cdot {u}_{item} mod q , \\ A \cdot ext ( {j}_{2} , {v}_{2} ) + A \cdot ext ( {\overline{j}}_{2} , {w}_{2} ) - G \cdot {v}_{1} = 0 mod q , \\ … … … \\ A \cdot ext ( {j}_{l} , p ) + A \cdot ext ( {\overline{j}}_{l} , {w}_{l} ) - G \cdot {v}_{l - 1} = 0 mod q ,\end{matrix} \qquad ( 9 )$$

We also have the equation

A·x−G·p=0 mod q,

which corresponds to the third clause.

Regarding Enc_{Regev} ((B,Pᵢ)bin(j))=cᵢ, i=1,2, we have to prove satisfiability of the following equations;

$$\{ \begin{matrix}B \cdot {r}_{b} = {c}_{b , 1} mod q , for b = 1 , 2 \\ {P}_{b} \cdot {r}_{b} + ⌊ \frac{q}{2} ⌉ \cdot {( {j}_{1} , ⋯ , {j}_{l} )}^{T} = {c}_{b , 2} mod q , for b = 1 , 2.\end{matrix} \qquad ( 10 )$$

Now that we have all the equations that we need to prove their satisfiability, we can simply use (decomposition) extension-permutation techniques [Ste96, LNSW13, LNWX17], to transform all the previous equations into one big equation of the form

M·z=y (11)

where z is a valid witness. Note that, to prove that p≠0^{nk}, one can use the same tweak originally given in [LNSW13]; namely, during the extension phase, we will extend p∈{0,1}^{nk} to p*∈Bₙₖ^{2nk-1}, i.e., it has 2nk−1 bit length of which nk are ones. This proves that p had a least a 1 in it.

We still need to prove satisfiability of [symbol] = [symbol] _{Tag}(item)^{T}x+e. Let H= [symbol] _{Tag}(item)^{T∈} [symbol] _{q}^{n×m}. The tag equation can be rewritten as

H·x+I·e= [symbol] (12)

To combine the two equations (11) and (12), one can build a bigger equation that embeds both of them, for instance, we can construct the equation

$$\hat{M} \cdot \hat{z} = \hat{y} \\ where ; \\ \hat{M} = [ \begin{matrix}M & 0 \\ 0 \vert H \vert 0 & I\end{matrix} ] ; \hat{z} = [ \begin{matrix}\underline{⋮} \\ \underline{{x}^{*}} \\ \underline{⋮} \\ {e}^{*}\end{matrix} ] ; \hat{y} = [ \begin{matrix}\underline{y} \\ τ\end{matrix} ] , \qquad ( 13 )$$

where z=( . . . |χ*|. . . )^{T}, and x* is result of the decomposion-extension applied to x.

Finally, we can simply apply the abstracted Stern-like protocol given in Fig. (E.2) to equation (13) using the commitment scheme presented in [KTX08] to generate the argument of knowledge that we need for R_{ISIS}, which will be made interactive using the Fiat-Shamir transformation [FS86]. Note that, as we stated in Theorem 14, we get a statistical zero-knowledge argument of knowledge with soundness error 2/3 (hence the repetition [symbol] -times). This is true because the underlying commitment scheme is statistically hiding and computationally binding where the binding property relies on the hardness of SIV [symbol] .

1. A computer-implemented method for managing user-submitted reviews of items of goods or services, comprising:
maintaining an anonymous reputation system constructed from a group of group signature schemes run in parallel, wherein:
each item of a plurality of items of goods or services is associated uniquely with one of the group signature schemes;
the anonymous reputation system allows a user to join the group signature scheme associated with the item when the anonymous reputation system receives information indicating that the user has performed a predetermined operation associated with the item;
the anonymous reputation system allows the user to submit a review of the item when the user has joined the group signature scheme associated with the item;
the anonymous reputation system is publicly linkable, such that where multiple reviews are submitted by the same user for the same item, the reviews are publicly linked to indicate that the reviews originate from the same user; and
the anonymous reputation system is configured to be non-frameable, wherein non-frameability is defined as requiring that it is unfeasible for one user to generate a valid review that traces or links to a different user.

2. The method of claim 1, wherein the anonymous reputation system is constructed so as to implement security based on lattice-based hardness assumptions rather than number-theoretic hardness assumptions.

3. The method of claim 1, wherein the anonymous reputation system assigns a public key and a secret key to each user.

4. The method of claim 3, wherein the allowing of a user to join the group signature scheme associated with an item comprises assigning a position in a Merkle-tree, the Merkle-tree corresponding to the item in question, and accumulating the public key of the user in the Merkle-tree.

5. The method of claim 4, wherein positions in the Merkle-tree are hashed to the top of the Merkle-tree using an accumulator instantiated using a lattice-based hash function.

6. The method of claim 5, wherein:
a path from the assigned position to the root of the Merkle-tree is provided by the anonymous reputation system to the user;
the root of the Merkle-tree is public; and
in order to be able to submit a review by generating a signature, the anonymous reputation system requires the user to prove in zero-knowledge that the user knows the pre-image of a public key that has been accumulated in the Merkle-tree and that the user knows of a path from the corresponding position in the Merkle-tree to the root of the Merkle-tree.

7. The method of claim 4, wherein the anonymous reputation systems allows a user to submit a review by generating a signature corresponding to the review by encrypting the assigned position in the Merkle-tree and computing a tag for the item.

8. The method of claim 7, wherein the computed tags are such as to be extractable from corresponding signatures and usable to determine whether any multiplicity of reviews for the same item originate from the same user.

9. The method of claim 7, wherein the computed tags are represented by vectors.

10. The method of claim 9, wherein the determination of whether any multiplicity of reviews for the same item originate from the same user comprises determining a degree of similarity between computed tags extracted from signatures corresponding to the reviews.

11. The method of claim 10, wherein the degree of similarity is determined based on whether a distance or difference between the computed tags is bounded by a predetermined scalar.

12. The method of 1, wherein the predefined operation comprises one or more of the following: purchasing the item, experiencing the item.

13. The method of 1, wherein the anonymous reputation system dynamically allows users to join and/or leave at any moment.

14. The method of claim 1, wherein the non-frameability of the anonymous reputation system is such that for any probabilistic polynomial time adversary it is unfeasible to generate a valid review that traces or links to an honest user even if the probabilistic polynomial time adversary is able to corrupt all other users and chose keys of a Group Manager and Tracing Manager of the anonymous reputation system.

15. The method of claim 1, wherein the anonymous reputation system is configured to be correct, where correctness is defined as requiring that reviews produced by honest, non-revoked users are always accepted by the anonymous reputation system, that an honest Tracing Manager of the anonymous reputation system can always identify the honest non-revoked user corresponding to such reviews, and that two reviews produced by the same user on the same item always link.

16. The method of claim 1, wherein the anonymous reputation system is configured to be anonymous, where anonymity is defined as requiring that for any probabilistic polynomial time adversary the probability of distinguishing between two reviews produced by any two honest users is negligible even if a Group Manager of the anonymous reputation system and all other users are corrupt and the adversary has access to a Trace oracle.

17. The method of claim 1, wherein the anonymous reputation system is configured to be traceable, where traceability is defined as requiring that for any probabilistic polynomial time adversary it is infeasible to output two reviews for the same item that trace to the same user but do not link, even if the adversary chose keys of a Group Manager and Tracing Manager of the anonymous reputation system.

18. The method of claim 1, wherein the public linkability of the anonymous reputation system is such that for any adversary it is unfeasible to output two reviews for the same item that trace to the same user but do not link, even if the adversary chose keys of a Group Manager and Tracing Manager of the anonymous reputation system.

19. The method of claim 1, wherein the anonymous reputation system is configured to be tracing sound, where tracing soundness is defined as requiring that no adversary can output a review that traces back to two different users even if the adversary can corrupt all user and chose keys of a Group Manager and Tracing Manager of the anonymous reputation system.

20. A computer program comprising instructions that when executed by a computer system cause the computer system to perform the method of claim 1.

21. A computer program product comprising the computer program of claim 20.

22. A computer system programmed to perform the method of claim 1.
